(19) United States
(12) Patent Application Publication
(10) Pub. No.: US 2026/0244841 A1
(43) Pub. Date: Aug. 20, 2026

(54) DETECTING AND REMOVING WIDOWS AND ORPHANS IN HIERARCHICAL TEXT

(71) Applicant: Adobe Inc., San Jose, CA (US)

(72) Inventors: Prateek Gaurav, Lucknow (IN); Pragya Kandari, Noida (IN); Anurag Singh, Noida (IN)

(21) Appl. No.: 19/058,755

(22) Filed: Feb. 20, 2025

(51) Int. Cl. G06F 40/106

(52) U.S. Cl. CPC G06F 40/106

(57) ABSTRACT

The present disclosure is directed toward systems, methods, and non-transitory computer readable media that adjust the display of hierarchical content to reduce disruption to text flow within a digital document. For example, the disclosed systems detect a hierarchical segment within a digital document that includes a hierarchical organization of elements in response to a selection of a document layout analysis tool via a graphical user interface. Furthermore, the disclosed systems detect an isolated element of the hierarchical segment positioned on a separate page or a separate column from other elements of the hierarchical segment. The disclosed systems determine a document layout penalty for the digital document based on a disruption to text flow within the digital document associated with the isolated element. In addition, the disclosed systems adjust display of the hierarchical segment by modifying attributes of the digital document to reduce the determined document layout penalty.

### BACKGROUND

Advancements in computing devices and digital content systems have led to increases in use and capabilities of digital document systems that process and display textual content. For example, many digital document systems perform a wide array of tasks for preparing and structuring digital content for use in many different use cases (e.g., by structuring textual content within digital documents. Generating digital documents to have a visual and structural flow that allows easy readability and aesthetic consistency is an important aspect of many digital documentation workflows, including product documentation and report generation, among many others. Due to the variable nature of text and/or media content (e.g., sizes, amounts), achieving such readability and consistency is often challenging in many digital content generation and editing software applications. Existing digital document systems face challenges in flexibility, efficacy, and operational efficiency for structuring content in digital documents.

### SUMMARY

One or more embodiments provide benefits and/or solve one or more of the foregoing or other problems in the art with systems, methods, and non-transitory computer readable storage media that adjust the display of hierarchical content within a digital document to reduce a disruption to text flow within the digital document. For example, the disclosed systems determine a selection (e.g., via a document layout analysis tool) to adjust the display of hierarchical segments (e.g., bullet lists, numbered lists) to improve the flow of content within a digital document by modifying hierarchical content elements (e.g., content blocks) of the hierarchical segments. In response to the selection, the disclosed systems detect one or more hierarchical segments that include isolated (e.g., widowed or orphaned) hierarchically organized textual elements within the digital document. In one or more embodiments, the disclosed systems determine a document layout penalty for the digital document reflecting a disruption to the text flow of the digital document associated with the isolated element. In some embodiments, the disclosed systems adjust the display of the hierarchical segment within the digital document by modifying attributes of the digital document to reduce the document layout penalty as well as reduce the associated disruption to the text flow.

### BRIEF DESCRIPTION OF THE DRAWINGS

This disclosure will describe one or more example embodiments of the systems and methods with additional specificity and detail by referencing the accompanying figures. The following paragraphs briefly describe those figures, in which:

FIG. 1 illustrates a schematic diagram of an example environment of a hierarchical flow optimization system in accordance with one or more embodiments;

FIG. 2 illustrates an example overview of the hierarchical flow optimization system adjusting the display of hierarchical content of a digital document in accordance with one or more embodiments;

FIG. 3 illustrates an example of the hierarchical flow optimization system generating a document layout penalty in accordance with one or more embodiments;

FIGS. 4A-4B illustrate an example of the hierarchical flow optimization system utilizing a penalty minimization model to update attribute values for a digital document in accordance with one or more embodiments;

FIGS. 5A-5D illustrate example graphical user interfaces of the hierarchical flow optimization system adjusting the display of hierarchical content of a digital document in accordance with one or more embodiments;

FIGS. 6A-6B illustrate example graphical user interfaces of a hierarchical flow optimization system adjusting the display of paragraphs of hierarchical content within a digital document in accordance with one or more embodiments;

FIG. 7 illustrates a diagram of an example architecture of the hierarchical flow optimization system in accordance with one or more embodiments;

FIG. 8 illustrates a flowchart of a series of acts for adjusting display of hierarchical content within a digital document in accordance with one or more embodiments; and

FIG. 9 illustrates a block diagram of an example computing device in accordance with one or more embodiments.

### DETAILED DESCRIPTION

This disclosure describes one or more embodiments of a hierarchical flow optimization system that adjusts the display of hierarchical content within a digital document by modifying hierarchical content elements to reduce disruption to text flow within the digital document. In one or more embodiments, the hierarchical flow optimization system determines, based on an interaction with a document layout analysis tool via a graphical user interface, a selection to adjust the display of hierarchical segments within a digital document. In response to the selection via the document layout analysis tool, embodiments of the hierarchical flow optimization system detect a hierarchical segment that includes hierarchically organized textual elements (e.g., content blocks) within the digital document and identifies an isolated element (e.g., widow, orphan, separated multi-line element) of a hierarchical segment. The hierarchical flow optimization system determines a document layout penalty for the digital document reflecting a disruption to text flow within the digital document associated with the isolated element and/or other isolated paragraph-based or hierarchical elements of the digital document. The hierarchical flow optimization system adjusts the display of the hierarchical segment within the digital document by modifying attributes of the digital document to reduce the document layout penalty and the associated disruption to the text flow.

More specifically, in one or more embodiments, the hierarchical flow optimization system detects one or more hierarchical segments within a digital document. For example, in response to a selection via a document layout analysis tool to optimize a flow/layout of a digital document, the hierarchical flow optimization system detects hierarchical segments including hierarchical structures of textual elements such as bullet lists, numbered lists, tables of contents, indexes, and/or nested lists. Furthermore, in some embodiments, the hierarchical flow optimization system detects isolated elements (e.g., content blocks) corresponding to the hierarchical segments of the digital document. For example, the hierarchical flow optimization system detects isolated elements of hierarchical segments separating the elements across different positioned on a separate page, column, or section from other elements of the corresponding hierarchical segments (e.g., such as widows or orphans).

In one or more embodiments, the hierarchical flow optimization system determines a document layout penalty that quantifies the disruption to the text flow of the digital document associated with isolated elements within the digital document. For example, the hierarchical flow optimization system determines the document layout penalty based on the severity of the text flow disruption associated with isolated elements in hierarchical content and also in paragraph-based content. In certain embodiments, the hierarchical flow optimization system weights the document layout penalty based on either grouping or balancing the hierarchical segments within the digital document. In one or more embodiments, to determine the document layout penalty, the hierarchical flow optimization system weights the isolated elements from different types of textual segments independently, reflective of the varying disruptive impact of isolated elements from different types of textual segments to the text flow of the digital document.

In certain embodiments, the hierarchical flow optimization system updates attributes of the digital document to reduce the document layout penalty. For example, the hierarchical flow optimization system modifies attributes of the digital document to reduce instances of isolated hierarchical elements and reduce the disruption to text flow caused by various types of content including hierarchical content. In some cases, the hierarchical flow optimization system modifies typographical attributes of the digital document including justification, hyphenation, glyph spacing, word spacing, and/or glyph scaling. In one or more embodiments, the hierarchical flow optimization system performs iterative modifications to the attributes to reduce the document layout penalty. For example, the hierarchical flow optimization system iteratively modifies the attributes until convergence (e.g., until changes to the document layout penalty become negligible or meet a penalty convergence threshold).

In one or more embodiments, the hierarchical flow optimization system provides digital documents for display on a graphical user interface of a client device. For example, the hierarchical flow optimization system provides a digital document for display on the client device, wherein the digital document includes paragraph-based content and/or hierarchical content. In some cases, the hierarchical flow optimization system displays adjustments to the layout of the digital document based on modifications to the attributes of the digital document. For example, after modifying values of one or more attributes to reduce text flow disruption within the digital document, the hierarchical flow optimization system displays an updated digital document by implementing the modified attribute values.

As mentioned, existing systems have a number of shortcomings, particularly in terms of flexibility, efficacy, and operational efficiency in structuring content within digital documents. For example, existing systems are inflexible and focus only on correcting widows or orphans introduced in paragraph-based content due to the pagination or layout of a digital document. To illustrate, because many existing systems are limited to basic paragraph-level analysis to identify/correct widows or orphans, these existing systems fail to account for layout issues due to other types of content in the digital document. As a result, existing systems often generate digital documents with disruptively isolated elements of other content types (e.g., hierarchical content such as bullet lists, numbered lists, indexes, and tables of contents), resulting in reduced document readability when such content structures are present.

Additionally, existing systems are ineffective. For example, because existing systems focus solely on paragraph-based widows and orphans, the systems lack the capability to mitigate the cumulative impact of isolated elements of different content types on document readability (e.g., text flow). Indeed, existing systems often prioritize isolated paragraph-based adjustments without considering how the adjustments to the paragraph-based content impact the other types of content in the digital document. Specifically, the existing systems reduce instances of widows or orphans for paragraph content, these existing systems fail to account for the holistic effect of the isolated paragraph content on the text flow of the digital document. For example, existing systems apply isolated fixes that often inadvertently create isolated list elements on a separate page, column, or section.

Relatedly, the inflexibility and ineffectiveness of existing systems leads to operational inefficiencies. For example, existing systems often require multiple device interactions to correct for separated hierarchical groupings or to reunite isolated elements in digital documents caused by predefined, rigid formatting rules. Furthermore, as mentioned with many existing systems, correcting content in earlier portions of a digital document causes the subsequent text to reflow, often introducing new instances of widows and orphans in later portions of the digital document. As a result, when performing document modifications, existing systems often require an excessive number of device interactions to correct newly introduced widows and orphans throughout the digital document, often requiring additional searching of the digital document or different settings for different sections of a digital document. Additionally, even for existing systems that utilize paragraph-level analysis to identify isolated lines, these existing systems require specialized handling (and additional device interactions) when correcting isolated elements in different languages (e.g., longer words in German, or right-to-left in Arabic).

As suggested above, embodiments of the hierarchical flow optimization system overcome these and other disadvantages inherent in existing systems. Unlike existing systems that are inflexibly incapable of maintain text continuity for non-paragraph-based content, embodiments of the hierarchical flow optimization system detect and correct for isolated hierarchical elements within a digital document in addition to paragraph-based content. For example, embodiments of the hierarchical flow optimization system provide the flexibility of various options to group hierarchical elements or balance hierarchical elements throughout a digital document. Furthermore, rather than solely relying on paragraph-level analysis to identify isolated lines, embodiments of the hierarchical flow optimization system employ context-aware balancing methods that analyze both hierarchical structures as well as paragraph-level content. Through a holistic evaluation, embodiments of the hierarchical flow optimization system optimize text flow across diverse content types, including bullet lists, numbered lists, indexes, paragraphs, and tables of contents, improving overall document flow.

In one or more embodiments, the hierarchical flow optimization system improves upon the efficacy of existing systems by adjusting document attributes utilizing a gradient descent model. For instance, by leveraging a gradient descent model, the hierarchical flow optimization system iteratively adjusts typographical document attributes, such as spacing and layout parameters, to optimize hierarchical and paragraph-based content layout and improve overall document readability. Furthermore, embodiments of the hierarchical flow optimization system apply a penalty-based evaluation to individually weight different content types based on their impact on overall text flow. Utilizing the penalty-based evaluation, embodiments of the hierarchical flow optimization system prioritize the most beneficial adjustments to the digital document, ensuring that disruptions to text flow caused by different types of content (including hierarchical content) are effectively minimized.

Consequently, embodiments of the hierarchical flow optimization system provide significant operational efficiencies over existing systems. As mentioned above, existing systems require an excessive number of user interactions to individually correct for instances of isolated hierarchical content (including new instances caused by text reflow). In contrast, based on a single user selection, embodiments of the hierarchical flow optimization system adjust attribute values of the digital document to optimize the text flow of a complete digital document, eliminating the need for repeated device interactions. Similarly, embodiments of the hierarchical flow optimization system perform efficiently across diverse languages, accounting for differences in word length, spacing, and text direction. For example, the hierarchical flow optimization system accommodates longer words in German and right-to-left in Arabic, ensuring efficient document formatting requiring minimal device interactions across different linguistic structures.

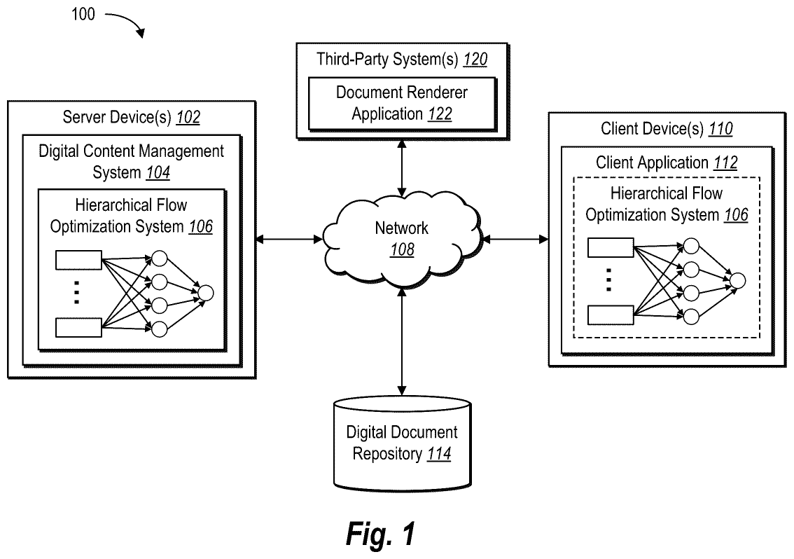

Additional detail regarding the hierarchical flow optimization system will now be provided with reference to the figures. For example, FIG. 1 illustrates a schematic diagram of an exemplary system environment (e.g., environment 100) in which a hierarchical flow optimization system 106 operates. As illustrated in FIG. 1, the environment 100 includes server device(s) 102, a network 108, client device(s) 110, digital document repository 114, and third-party system(s) 120.

Although the environment 100 of FIG. 1 is depicted as having a particular number of components, the environment 100 is capable of having any number of additional or alternative components (e.g., any number of servers, client devices, or other components) in communication with the hierarchical flow optimization system 106 via the network 108. Similarly, although FIG. 1 illustrates a particular arrangement of the server device(s) 102, the network 108, the client device(s) 110, the digital document repository 114, and the third-party system(s) 120, various additional arrangements are possible.

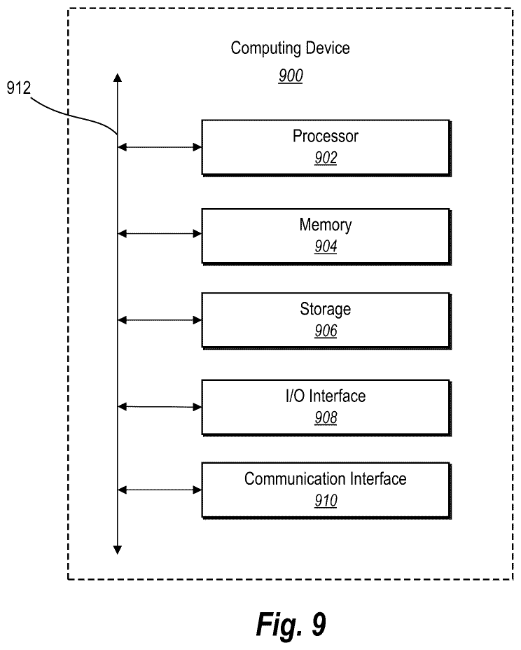

The server device(s) 102, the network 108, the client device(s) 110, the digital document repository 114, and the third-party system(s) 120 are communicatively coupled with each other either directly or indirectly (e.g., through the network 108 discussed in greater detail below in relation to FIG. 9). Moreover, the server device(s) 102 and the client device(s) 110 include one of a variety of computing devices (including one or more computing devices as discussed in greater detail with relation to FIG. 9).

As illustrated in FIG. 1, the environment 100 includes the server device(s) 102 and the digital content management system 104. The server device(s) 102 utilizes the digital content management system 104 to generate, track, store, process, receive, and transmit electronic data including digital documents, hierarchical content, paragraph content, document attributes, and document layout penalties. For example, the server device(s) 102 receives or monitors interactions across the client device(s) 110. In some embodiments, the server device(s) 102 transmits content to the client device(s) 110 to cause the client device(s) 110 to display and execute content associated with generating document layout penalties and adjusting the layout of digital documents. For example, the server device(s) 102 presents the digital documents, hierarchical content, textual content, document attributes, and document layout penalties to client device(s) 110 and displays and/or determines the digital documents, hierarchical content, paragraph content, document attributes, and document layout penalties on the client device(s) 110 with the digital documents, hierarchical content, paragraph content, document attributes, and document layout penalties, displayed and/or determined corresponding to system need (e.g., provides digital documents, hierarchical content, paragraph content, document attributes, and document layout penalties for display and/or determination via the client application 112). The server device(s) 102 further accesses and utilizes the digital document repository 114 to store and retrieve information such as digital documents, hierarchical content, paragraph content, document attributes, document layout penalties, and/or other data.

Additionally, the server device(s) 102 includes all, or a portion of, the hierarchical flow optimization system 106. For example, the hierarchical flow optimization system 106 operates on the server device(s) 102 to access digital content (including digital documents, hierarchical content, paragraph content, document attributes, and document layout penalties), determine digital content changes, execute digital content, and provide localization of content changes to the client device(s) 110 and/or finetune large language models. In one or more embodiments, via the server device(s) 102, the hierarchical flow optimization system 106 generates, executes, and displays digital documents, hierarchical content, paragraph content, document attributes, and document layout penalties based on the client device(s) 110 input. Example components of the hierarchical flow optimization system 106 will be described below with regard to FIG. 9.

Furthermore, as shown in FIG. 1, the illustrated system includes the client device(s) 110. In some embodiments, the client device(s) 110 include, but are not limited to, mobile devices (e.g., smartphones, tablets), laptop computers, desktop computers, or another type of computing devices, including those explained below in reference to FIG. 9. Some embodiments of client device(s) 110 are operated by a user to perform a variety of functions via client application 112 such as the generation/modification of the digital documents, hierarchical content, paragraph content, document attributes, and document layout penalties. The client device(s) 110 include one or more applications (e.g., the client application 112) that access, edit, modify, store, execute, and/or provide, for display, digital documents, hierarchical content, paragraph content, document attributes, and document layout penalties. For example, in some embodiments, the client application 112 includes a software application installed on the client device(s) 110. In other cases, however, the client application 112 includes a web browser or other application that accesses a software application hosted on the server device(s) 102.

In one or more embodiments, the hierarchical flow optimization system 106 is implemented in whole, or in part, by the individual elements of the environment 100. Indeed, as shown in FIG. 1, the hierarchical flow optimization system 106 is implemented with regard to the server device(s) 102 and the client device(s) 110. In particular embodiments, the hierarchical flow optimization system 106 on the client device(s) 110 comprises a web application, a native application installed on the client device(s) 110 (e.g., a mobile application, a desktop application, a plug-in application, etc.), or a cloud-based application where part of the functionality is performed by the server device(s) 102.

In additional or alternative embodiments, the hierarchical flow optimization system 106 on the client device(s) 110 represents and/or provides the same or similar functionality as described herein in connection with the hierarchical flow optimization system 106 on the server device(s) 102. In some embodiments, the hierarchical flow optimization system 106 on the server device(s) 102 supports the hierarchical flow optimization system 106 on the client device(s) 110.

In some embodiments, the hierarchical flow optimization system 106 includes a web hosting application that allows the client device(s) 110 to interact with content and services hosted on the server device(s) 102. To illustrate, in one or more embodiments, the client device(s) 110 accesses a web page or computing application supported by the server device(s) 102. The client device(s) 110 provides input to the server device(s) 102 (e.g., user interactions). In response, the hierarchical flow optimization system 106 on the server device(s) 102 generates and/or determines digital documents, hierarchical content, paragraph content, document attributes, and document layout penalties. The server device(s) 102 then provides the digital documents, hierarchical content, paragraph content, document attributes, and/or document layout penalties to the client device(s) 110.

In some embodiments, the hierarchical flow optimization system 106 includes the third-party system(s) 120 and document renderer application 122. To illustrate, in one or more embodiments, the hierarchical flow optimization system 106 interacts with content and services hosted on the third-party system(s) 120. To illustrate, in one or more embodiments, the hierarchical flow optimization system 106 accesses a web page or computing application supported by the third-party system(s) 120. The third-party system(s) 120 provide input to the hierarchical flow optimization system 106 and document renderer application 122. In response, the hierarchical flow optimization system 106 generates/modifies digital content including digital documents, hierarchical content, paragraph content, document attributes, and document layout penalties and/or interacts with the document renderer application 122 to generate/modify digital content including digital documents, hierarchical content, paragraph content, document attributes, and document layout penalties. The hierarchical flow optimization system 106 then provides the digital content to the third-party system(s) 120.

In some embodiments, though not illustrated in FIG. 1, the environment 100 has a different arrangement of components and/or has a different number or set of components altogether. For example, in certain embodiments, the client device(s) 110 communicate directly with the server device(s) 102, bypassing the network 108. As another example, the environment 100 includes a third-party server comprising a content server and/or a data collection server.

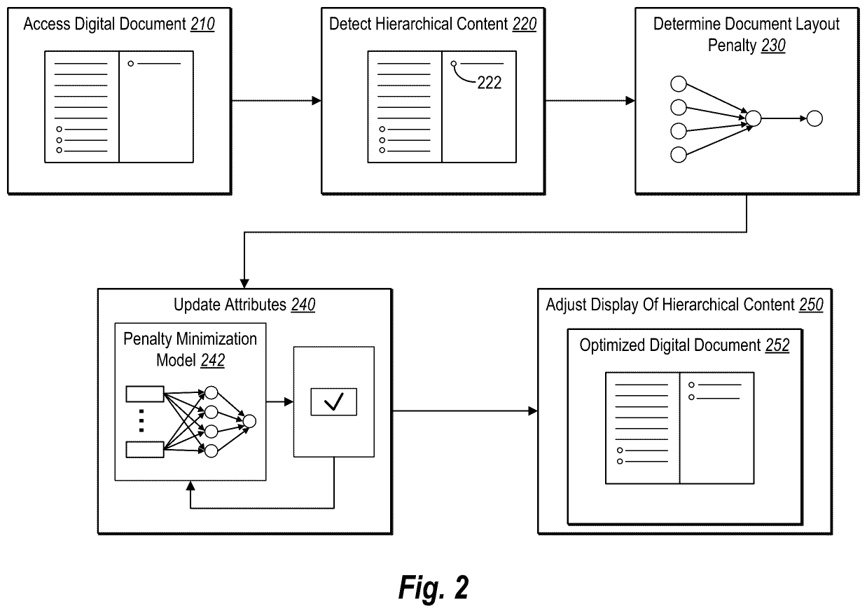

As previously mentioned, in one or more embodiments, the hierarchical flow optimization system 106 adjusts hierarchical content within a digital document by updating document attributes to reduce disruption in text flow. For instance, FIG. 2 illustrates an example overview of the hierarchical flow optimization system adjusting the display of hierarchical content of a digital document in accordance with one or more embodiments. Additional detail regarding the various acts of FIG. 2 is provided thereafter with reference to subsequent figures.

In one or more embodiments, the hierarchical flow optimization system 106 performs an act 210 to access a digital document. For example, the hierarchical flow optimization system 106 performs the act 210 by accessing the digital document via a document rendering application, which accesses, edits, modifies, stores, and/or displays digital documents. As used herein, a digital document includes textual content organized as non-hierarchical content and/or hierarchical content. For example, the digital document includes hierarchical content structured in a ranked or nested format, where relationships between sections, subsections, blocks, and/or elements follow a logical order. In some embodiments, the digital document includes non-hierarchical content such as paragraphs.

In some cases, the digital document includes segments of hierarchical content including hierarchical structures such as bullet lists, numbered lists, tables of contents, indexes, and/or nested lists. Furthermore, the hierarchical content includes hierarchical elements. In one or more embodiments, hierarchical elements include or refer to individual components that contribute to the content, structure, formatting, or presentation of hierarchical content. For example, hierarchical elements include atomic (e.g., standalone) or nested (e.g., hierarchically dependent on other elements) within a hierarchical content. In some cases, hierarchical elements include components such as bullet-points, numbered list-items, headings, subheadings, or content sections.

In addition, embodiments of the hierarchical flow optimization system 106 perform an act 220 to detect hierarchical content within the digital document. For example, the hierarchical flow optimization system 106 performs the act 220 to detect, within the digital document, one or more hierarchical segments in response to a selection of a document layout analysis tool via a graphical user interface displaying the digital document. To illustrate, the hierarchical flow optimization system 106 detects one or more instances of a bullet list, numbered list, table of contents, index, and/or nested list within the digital document.

As part of the act 220, embodiments of the hierarchical flow optimization system 106 detects one or more of the isolated element 222 within the hierarchical segments of the digital document. In one or more embodiments, the isolated element 222 includes or refers to an individual element of hierarchical content that becomes visually or functionally separated from the other elements of the hierarchical segment (e.g., due to layout constraints). In some cases, the hierarchical flow optimization system 106 determines the isolated element 222 based on the position of the isolated element 222 on a separate page, column, or section than the other elements of the corresponding hierarchical segment. To illustrate, the hierarchical flow optimization system 106 determines the isolated element 222 such as a single bullet or numbered step alone at the top/bottom of a page (e.g., a widow or an orphan), a multi-line bullet spanning two pages (e.g., isolated lines within a hierarchical element), and/or a section title positioned alone the top/bottom of a page (e.g., with the corresponding content on another other page).

Notably, embodiments of the hierarchical flow optimization system 106 identify orphaned or widowed elements (rather than merely lines of text) for complex, nested, or hierarchical content. For example, the hierarchical flow optimization system 106 identifies isolated elements of hierarchical segments including entire content blocks or paragraphs. In one or more embodiments, the hierarchical flow optimization system 106 identifies a single element, or a portion of a single element, that spills onto a new page and functionally represents an isolated hierarchical element that disrupts the text flow of the digital document. In some cases, the hierarchical flow optimization system 106 identifies a group of elements (e.g., nested hierarchical content) that spills onto a new page and functionally represents an isolated group of elements that disrupts the text flow of the digital document. For example, the hierarchical flow optimization system 106 detects instances of hierarchical content where a paragraph, bullet-point, list-item, or nested group of elements is orphaned-including the entirety of a content element that starts or ends on a different page.

In one or more embodiments, the hierarchical flow optimization system 106 performs an act 230 to determine a document layout penalty. For example, the hierarchical flow optimization system 106 determines a document layout penalty that quantifies the disruption to the text flow of the digital document caused by isolated elements in the digital document. For example, the hierarchical flow optimization system 106 utilizes the document layout penalty to quantify the readability, logical structure, and visual coherence of the digital document.

In certain cases, the hierarchical flow optimization system 106 determines the document layout penalty based on the severity of the disruption to text flow caused by the isolated elements. For example, in some cases where only a small portion of a hierarchical segment is isolated, the hierarchical flow optimization system 106 determines a lower document layout penalty than if a significant portion of the hierarchical segment is isolated. In one or more embodiments, the hierarchical flow optimization system 106 determines the document layout penalty by weighting the different types of textual content (e.g., bullet lists, numbered lists, tables of contents, indexes, and/or nested lists, paragraph content) independently, reflective of a varying disruptive impact to the text flow from the different types of textual content.

In certain embodiments, the hierarchical flow optimization system 106 performs an act 240 to update attributes of the digital document. For example, the hierarchical flow optimization system 106 utilizes a penalty minimization model 242 to update the attributes of the digital document and reduce the document layout penalty (thereby reducing instances of isolated hierarchical elements and reducing disruption to text flow). In some cases, the hierarchical flow optimization system 106 performs the act 240 by modifying attributes of the digital document such as the typographical or page attributes of justification, hyphenation, glyph spacing, word spacing, glyph scaling/font size, margin adjustments, paragraph indentation, and/or baseline alignment.

In certain embodiments, based on an interdependence between the document attributes, the penalty minimization model 242 performs iterative modifications to the attributes to reduce the document layout penalty. For example, embodiments of the hierarchical flow optimization system 106 utilize the penalty minimization model 242 to iteratively modify the attributes until the penalty minimization model 242 converges. Thus, embodiments of the hierarchical flow optimization system 106 utilize the penalty minimization model 242 to collectively modify the attributes for the digital document until changes to the document layout penalty become negligible or meet a penalty convergence threshold.

In one or more embodiments, the hierarchical flow optimization system 106 performs an act 250 to adjust the display of the hierarchical content of the digital document. For example, based on the updated attributes generated in act 240, the hierarchical flow optimization system 106 adjusts display the hierarchical content of the digital document by adjusting the layout of the digital document to generate an optimized digital document 252. In certain embodiments, the hierarchical flow optimization system 106 applies optimal values for the attributes (selected based on the convergence of the penalty minimization model 242) to the digital document as character style overrides, causing the digital document layout to adapt in a way that reduces isolated elements while maintaining the overall visual integrity of the digital document.

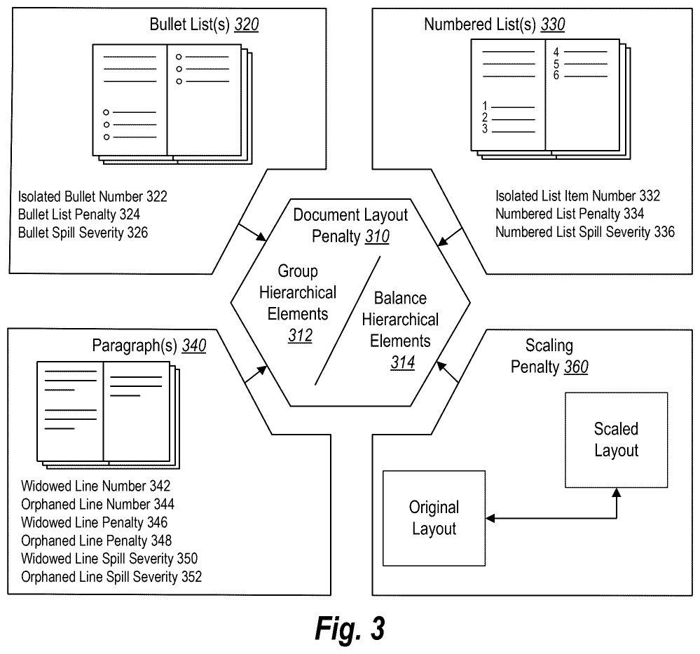

As mentioned, the hierarchical flow optimization system 106 determines a document layout penalty for a digital document based on a disruption to text flow within the digital document associated with isolated elements of textual content. FIG. 3 illustrates an example of generating a document layout penalty in accordance with one or more embodiments.

As shown in FIG. 3, the hierarchical flow optimization system 106 generates a document layout penalty 310 based on textual content. For example, the hierarchical flow optimization system 106 generates the document layout penalty 310 based on bullet list(s) 320, numbered list(s) 330, paragraph(s) 340, nested bullet list(s), tables of content(s), and/or index(es). Embodiments of the hierarchical flow optimization system 106 determine the document layout penalty 310 based on how severely the text flow is disrupted by instances of isolated elements within the digital document for the bullet list(s) 320, the numbered list(s) 330, the paragraph(s) 340, the nested bullet list(s), the tables of content(s), and/or the index(es). For example, the hierarchical flow optimization system 106 incorporates a lower penalty in the document layout penalty 310 for hierarchical segments where only a small portion of a hierarchical segment is orphaned. Similarly, embodiments of the hierarchical flow optimization system 106 incorporates a higher penalty in the document layout penalty 310 for hierarchical segments where a significant part of the hierarchical segment is orphaned.

To illustrate, in one or more embodiments, the hierarchical flow optimization system 106 calculates the document layout penalty 310 utilizing a formula such as the following:

$$D L {P}_{penalty} = \frac{( {n}_{w} \times {p}_{w} ) + ( {n}_{o} \times {p}_{o} ) + ( {n}_{b} \times {p}_{b} ) + ( {n}_{n} \times {p}_{n} ) + ( {spill}_{severity} \times {p}_{spill} )}{{n}_{total}} + {p}_{scale \_ layout}$$

### Where:

n_{w}: Number of widowed lines in the paragraph(s) 340.
nₒ: Number of orphaned lines in the paragraph(s) 340.
n_{b}: Number of bullets that are widows/orphans in the bullet list(s) 320.
nₙ: Number of numbered list-items that are widows/orphans in the numbered list(s) 330.
P_{w}>Pₒ, P_{b}, Pₙ: Penalties assigned to each corresponding type of widow/orphan (e.g., n_{w}, nₒ, n_{b}, nₙ). Reflects how disruptive the widow/orphan is to the text flow of the digital document.
spill_{severity}: How much of a block (paragraph or hierarchical content) spills over to the next page or column. A value between 0 and 1 that represents the fraction of content spilled such as:

$${spill}_{severity} = \frac{spilled\_content}{total\_block \_content}$$

pₛₚᵢₗₗ: Penalty for content spill. Reflects how disruptive a partially spilled block is, with larger spills given higher penalties.
nₜₒₜₐₗ: Total number of lines in the digital document. Normalizes the penalty based on document size.
P_{scale_layout}: Accounts for penalties based on font scaling, word spacing, glyph spacing, or justification that affect the isolated elements. Computed by comparing the current layout with an idealized layout with nₒ isolated elements.

As shown, embodiments of the hierarchical flow optimization system 106 incorporate penalty values for both hierarchical content and non-hierarchical content to generate the document layout penalty 310. For example, the hierarchical flow optimization system 106 incorporates a widowed line penalty (n_{w}×p_{w}), an orphaned line penalty (nₒ×Pₒ), a widow/orphan bullet list penalty (nₚ×p_{b}), a numbered list-item penalty (nₙ×pₙ), and a spill severity penalty to generate the document layout penalty 310. Additionally, the hierarchical flow optimization system 106 adds a scale penalty 360 (P_{scale_layout}) based on an ideal/target layout for the digital document.

To illustrate, embodiments of the hierarchical flow optimization system 106 generate the document layout penalty 310 based on the hierarchical content of the bullet list(s) 320. For example, the hierarchical flow optimization system 106 determines an isolated bullet number 322 (e.g., nₚ) corresponding to the number of elements of the bullet list(s) 320 that become isolated across pages or columns (e.g., isolated bullets from one or more of the bullet list(s) 320). In addition, embodiments of the hierarchical flow optimization system 106 modify the document layout penalty 310 based on the bullet spill severity 326 (e.g., spill_{severity}), which denotes a fraction of the bullet list(s) 320 that spills over to the next page, section, or column.

As also shown, embodiments of the hierarchical flow optimization system 106 modify the document layout penalty 310 based on a bullet list penalty 324 (e.g., p_{b}). For example, the hierarchical flow optimization system 106 utilizes the bullet list penalty 324 to weight the contribution of the isolated bullet number 322 for the document layout penalty 310. For instance, the hierarchical flow optimization system 106 utilizes a higher value for the bullet list penalty 324 if the hierarchical flow optimization system 106 determines hierarchical content is important in the digital document. Similarly, embodiments of the hierarchical flow optimization system 106 utilize a lower value for the bullet list penalty 324 if the hierarchical flow optimization system 106 determines hierarchical content is not as important in the digital document.

Similarly, embodiments of the hierarchical flow optimization system 106 generate the document layout penalty 310 based on the numbered list(s) 330. For example, the hierarchical flow optimization system 106 determines an isolated list-item number 332 (e.g., nₙ) corresponding to the number of isolated list-items of the numbered list(s) 330 (e.g., the number of widow/orphan list-items across pages, sections, or columns of the digital document). In addition, embodiments of the hierarchical flow optimization system 106 modify the document layout penalty 310 based on the numbered list spill severity 336 (e.g., spill_{severity}) which denotes a fraction of the numbered list(s) 330 that spills over to the next page, section, or column. As also shown, embodiments of the hierarchical flow optimization system 106 modify the document layout penalty 310 to reflect the contribution of the numbered list(s) 330 to the text flow of the digital document by weighting the isolated list-item number 332 by a numbered list penalty 334 (e.g., Pₙ).

In one or more embodiments, the hierarchical flow optimization system 106 generates the document layout penalty 310 based additional hierarchical content types. For example, the hierarchical flow optimization system 106 generates the document layout penalty 310 based on hierarchical content such as nested bullet list(s), tables of content(s), and/or index(es). In particular, in some cases the hierarchical flow optimization system 106 generates the document layout penalty for other types of hierarchical content as described above in relation to the bullet list(s) 320 and/or the numbered list(s) 330.

Relatedly, the hierarchical flow optimization system 106 generates the document layout penalty based on non-hierarchical content including the paragraph(s) 340. For example, embodiments of the hierarchical flow optimization system 106 detect isolated lines corresponding to the paragraph(s) 340. In some cases, the hierarchical flow optimization system 106 determines a widowed line number 342 (e.g., n_{w}) corresponding to a number of widowed lines in the paragraph(s) 340 and an orphaned line number 344 (e.g., nₒ) corresponding to a number of orphaned lines in the paragraph(s) 340. In addition, embodiments of the hierarchical flow optimization system 106 modify the document layout penalty 310 based on a widowed line spill severity 350 and an orphaned line spill severity 352 representing a fraction of the paragraph(s) 340 corresponding to widows and orphans that spill over between pages, columns, or sections.

As also shown, embodiments of the hierarchical flow optimization system 106 modify the document layout penalty 310 based on a widowed line penalty 346 (e.g., p_{w}), which weights the widowed line number 342 based on the contribution of the widows of the paragraph(s) 340 to the text flow of the digital document. Similarly, embodiments of the hierarchical flow optimization system 106 modify the document layout penalty 310 based on an orphaned line penalty 348 (e.g., Pₒ) which weights the orphaned line number 344 based on the contribution of the orphaned lines of the paragraph(s) 340 to the text flow of the digital document.

As mentioned, embodiments of the hierarchical flow optimization system 106 generate the document layout penalty 310 based on a spill severity which accounts for how much of the bullet list(s) 320, the numbered list(s) 330, the paragraph(s) 340, the nested bullet list(s), the tables of content(s), or the index(es) spills between pages, columns, or sections. In one or more embodiments, the hierarchical flow optimization system 106 utilizes a spill severity corresponding to a size of the content spill of an element onto a separate page or a separate column in comparison with a size of the textual segment. For example, the hierarchical flow optimization system 106 represents the spill severity for the bullet list(s) 320, the numbered list(s) 330, the paragraph(s) 340, the nested bullet list(s), the tables of content(s), or the index(es) as a fraction (e.g., between 0 and 1) such that

$$spill \_severity = \frac{spilled\_content}{total\_block \_content} .$$

In one or more embodiments, the hierarchical flow optimization system 106 determines the document layout penalty 310 utilizing a spill severity aggregated across all spills in the digital document, where each element i contributes a spill severity factor. For example, in some cases, the hierarchical flow optimization system 106 utilizes a spill_{severity} function such as the following to determine the document layout penalty 310:

$${spill}_{severity} = {\sum }_{i} ( \frac{{spilled\_content}_{i}}{total\_block {\_content}_{i}} )$$

In one or more embodiments, the hierarchical flow optimization system 106 modifies the document layout penalty 310 to reflect the contribution of the spill severity to the text flow of the digital document by weighting the spill severity by a spill penalty (e.g., spill_{severity}×Pₛₚᵢₗₗ). For example, the hierarchical flow optimization system 106 utilizes the spill penalty to reflect how disruptive the partially spilled content is to the text flow of the digital document, utilizing higher spill penalties for larger spills. In one or more embodiments, the hierarchical flow optimization system 106 determines the document layout penalty 310 utilizing a spill penalty aggregated across all spills in the digital document, where each element i contributes a spill severity factor weighted by a spill penalty P_{spill,i}. For example, in some cases, the hierarchical flow optimization system 106 determines a contribution of the spill severity (e.g., spill_{severity}×Pₛₚᵢₗₗ) to the document layout penalty 310 such as the following:

$${spill}_{severity} \times {p}_{spill} = {\sum }_{i} ( \frac{{spilled\_content}_{i}}{total\_block {\_content}_{i}} \times {p}_{spill , i} )$$

In one or more embodiments, the hierarchical flow optimization system 106 normalizes the document layout penalty 310 based on the digital document size. For example, the hierarchical flow optimization system 106 utilizes nₜₒₜₐₗ to account for digital documents of varying lengths. By normalizing the document layout penalty 310, the hierarchical flow optimization system 106 applies the document layout penalty 310 uniformly for digital documents.

As further shown in FIG. 3, embodiments of the hierarchical flow optimization system 106 utilize a scaling penalty 360 to determine the document layout penalty 310. Utilizing the scaling penalty 360, embodiments of the hierarchical flow optimization system 106 account for penalties based on changes to typographical attributes such as font scaling, word/glyph spacing, or justification that affect the text flow of the digital document (or, similarly, hyphenation, margin adjustments, paragraph indentation, and/or baseline alignment). In one or more embodiments, the hierarchical flow optimization system 106 determines the scaling penalty 360 by comparing the current layout with a generated layout without isolated elements.

In one or more embodiments, the hierarchical flow optimization system 106 utilizes the scaling penalty 360 to account for large scale isolated hierarchical elements within the digital document and/or the impacts of justification, font/word spacing, or other spacing/sizing attributes in the document layout penalty. For example, the hierarchical flow optimization system 106 utilizes the scaling penalty 360 to account for large scale titles and sub-titles within the digital document. In some cases, the hierarchical flow optimization system 106 normalizes the scaling penalty 360 for large font sizes, omitting the scaling penalty 360 from the document layout penalty. In some embodiments, the hierarchical flow optimization system 106 determines the scaling penalty 360 such as the following:

$${p}_{scale \_ layout} = {\sum }_{affected \_ blocks} ( {w}_{glyph} \cdot {Δ}_{glyph} + {w}_{w o r d} {Δ}_{w o r d} + {w}_{justification} \cdot {Δ}_{justification} )$$

### Where:

Δ_{glyph}: Change in glyph spacing after layout adjustment.
Δ_{word}: Change in word spacing after layout adjustment.
Δ_{justification}: Change in text justification after layout adjustment.
w_{glyph}, w_{word}, and w_{justification}: Weights that represent the relative impact of Δ_{glyph}, Δ_{word}, and Δ_{justification} on the P_{scale_layout}.

In some cases, the hierarchical flow optimization system 106 determines a higher value for the scaling penalty 360 to indicate a greater disruption in text flow due to the typographical adjustments—resulting in applying significant reformatting or layout corrections. In some cases, the hierarchical flow optimization system 106 determines a lower value for the scaling penalty 360 to indicate a lesser disruption in text flow due to typographical adjustments—resulting in applying lesser/minor reformatting or layout corrections.

As also shown in FIG. 3, embodiments of the hierarchical flow optimization system 106 determine the document layout penalty 310 based on a flow selection for aligning the hierarchical content. For example, the hierarchical flow optimization system 106 determines the document layout penalty 310 based on a flow selection 312 to group hierarchical elements of the digital document. As used herein, the flow selection 312 to group hierarchical elements, includes or refers to a selection to prioritize grouping the display of bullets and/or list-items of hierarchical segments together as a cohesive unit to reduce disruption to text flow. For example, based on the flow selection 312 to group hierarchical elements, the hierarchical flow optimization system 106 prioritizes grouping the hierarchical elements of hierarchical segments within the same page, column, or section. In some cases, if the hierarchical flow optimization system 106 determines that an entire group of hierarchical elements cannot fit onto an identified page, the hierarchical flow optimization system 106 modifies the document attributes and/or shifts the entire group of elements to the next page.

In one or more embodiments, the hierarchical flow optimization system 106 utilizes an additional penalty term p_{group_elements} to generate the document layout penalty 310 for the flow selection 312 to group hierarchical elements. To illustrate, in one or more embodiments, the hierarchical flow optimization system 106 calculates the document layout penalty 310 based on the flow selection 312 to group hierarchical elements such as the following:

$${DLP}_{penalty} = \frac{( {n}_{w} \times {p}_{w} ) + ( {n}_{o} \times {p}_{o} ) + ( {n}_{b} \times {p}_{b} ) + ( {n}_{n} \times {p}_{n} ) + ( {spill}_{severity} \times {p}_{spill} )}{{n}_{total}} + {p}_{scale \_ layout} + {p}_{group \_ elements}$$

More specifically, based on the flow selection 312 and through the use of the penalty P_{group_elements}, embodiments of the hierarchical flow optimization system 106 provide a penalty adjustment, which quantifies the impact of separating and/or grouping the elements of the hierarchical segments on the text flow.

In one or more embodiments, the hierarchical flow optimization system 106 determines the document layout penalty 310 based on a flow selection 314 to balance hierarchical elements of the digital document. As used herein, the flow selection 314 to balance hierarchical elements, includes or refers to a selection to prioritize balancing the display of bullets and/or list-items of hierarchical segments across pages to reduce disruption to text flow. For example, based on the flow selection 314 to balance the hierarchical elements, the hierarchical flow optimization system 106 divides the hierarchical elements into two equal groups (or approximately equal for uneven groups) to balance the hierarchical elements. In some cases, where the hierarchical flow optimization system 106 determines the entirety of both groups of hierarchical elements of cannot fit within a single page, the hierarchical flow optimization system 106 relocates the second group to the following page.

In one or more embodiments, the hierarchical flow optimization system utilizes a balancing penalty to generate the document layout penalty 310 for the flow selection 314 to balance hierarchical elements. For example, hierarchical flow optimization system 106 utilizes a balancing penalty, p_{balance_elements}, which is directly proportional to the balancing of the hierarchical elements of the digital document. To illustrate, in one or more embodiments, the hierarchical flow optimization system 106 calculates p_{balance_elements} utilizing a formula such as the following:

$${p}_{balance \_ elements} = ( {n}_{g 1} - {n}_{g 2} ) \cdot c$$

Where c is a constant, n_{g1} is the number of hierarchical elements in the first group and n_{g2} is the number of hierarchical elements in the second group. As shown, where both groups of elements contain an equal number of hierarchical elements, embodiments of the hierarchical flow optimization system 106 determine the balancing penalty to be zero. In cases where one group contains all the hierarchical elements, embodiments of the hierarchical flow optimization system 106 determine the balancing penalty to be a maximum value based on c.

In one or more embodiments, the hierarchical flow optimization system 106 calculates the document layout penalty 310 based on the flow selection 314 to balance hierarchical elements utilizing a formula such as the following:

$${DLP}_{penalty} = \frac{( {n}_{w} \times {p}_{w} ) + ( {n}_{o} \times {p}_{o} ) + ( {n}_{b} \times {p}_{b} ) + ( {n}_{n} \times {p}_{n} ) + ( {spill}_{severity} \times {p}_{spill} )}{{n}_{total}} + {p}_{scale \_ layout} + {p}_{balance \_ elements}$$

More specifically, based on the flow selection 314 and through the use of the penalty P_{balance_elements}, embodiments of the hierarchical flow optimization system 106 provide a penalty adjustment, which quantifies the impact of balancing the elements of the hierarchical segments on the text flow.

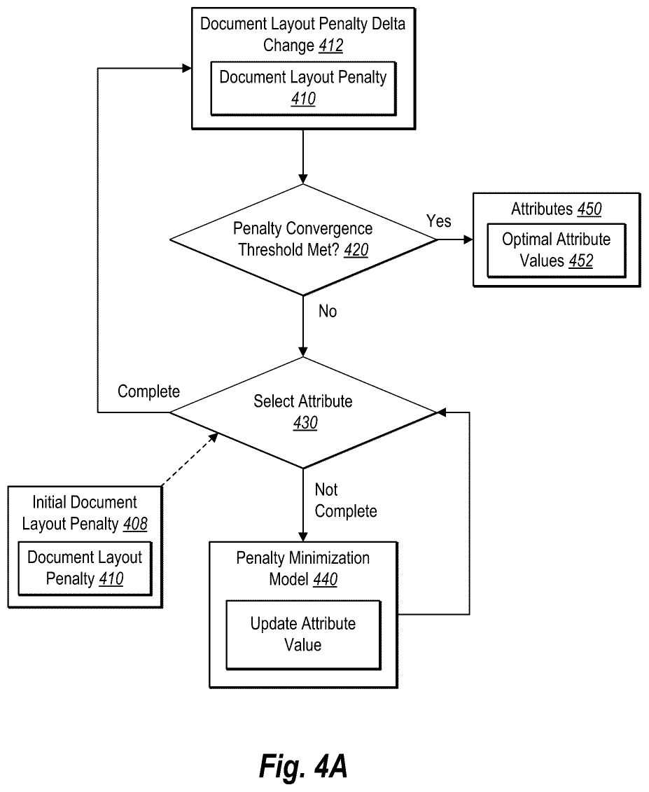

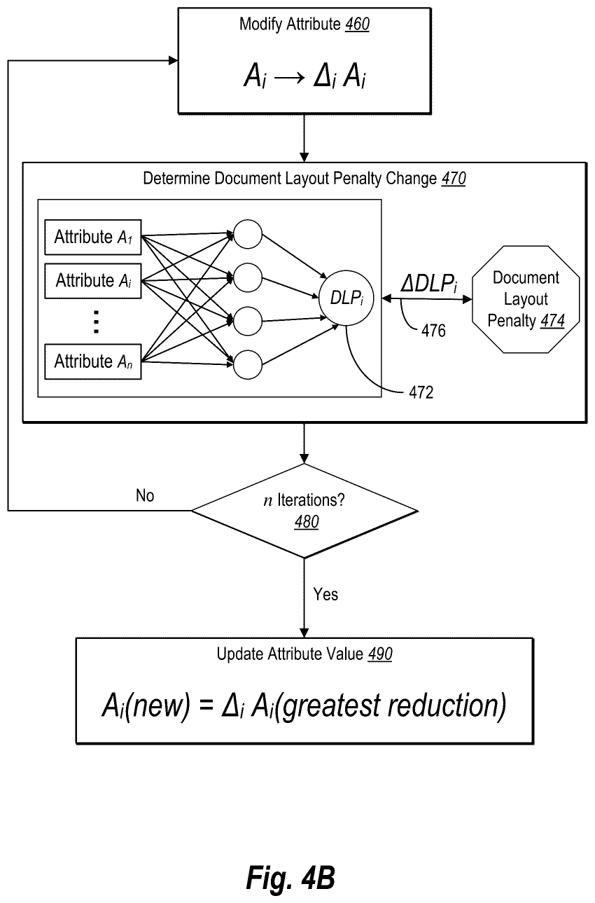

As mentioned, embodiments of the hierarchical flow optimization system 106 modify attributes of a digital document to reduce disruption to text flow associated with isolated elements. FIGS. 4A-4B illustrate an example of the hierarchical flow optimization system 106 utilizing a penalty minimization model to update attribute values to reduce disruption to text flow in a digital document in accordance with one or more embodiments.

As shown in FIG. 4A, the hierarchical flow optimization system 106 utilizes a penalty minimization model 440 to iteratively modify attributes 450 of a digital document until the document layout penalty 410 meets a penalty convergence threshold. For example, embodiments of the hierarchical flow optimization system 106 utilize the penalty minimization model 440 to update the attribute values of the digital document to determine optimal attribute values 452 for the attributes 450 to reduce the document layout penalty 410. In one or more embodiments, the hierarchical flow optimization system 106 utilizes an objective function to determine the optimal attribute values 452 such as the following:

$$J ( {n}_{w} , {n}_{o} , {n}_{b} , {n}_{n} , {n}_{g 1} , {n}_{g 2} ) = D L {P}_{penalty}$$

As shown, in one or more embodiments, the hierarchical flow optimization system 106 utilizes the penalty minimization model to perform the act 430 to select an attribute Aᵢ of the attributes 450. In some cases, the hierarchical flow optimization system 106 selects an attribute Aᵢ of the attributes 450 based on a high variability (e.g., an attribute Aᵢ responsive to changes, allowing for significant improvements in the text flow and the document layout penalty 410). In some cases, the hierarchical flow optimization system 106 performs the act 430 to iteratively select each of the attributes 450 as the attribute Aᵢ. In some cases, the hierarchical flow optimization system 106 performs the act 430 to iteratively select one or more of the attributes 450 as the attribute Aᵢ (e.g., based on system configuration or variability in the document layout penalty 410).

In one or more embodiments, the hierarchical flow optimization system 106 utilizes the penalty minimization model 440 to update the attributes 450. For example, using the penalty minimization model 440, the hierarchical flow optimization system 106 determines values for the attributes 450 (e.g., iteratively for each attribute Aᵢ) corresponding to local minima for the document layout penalty 410. In some embodiments, the hierarchical flow optimization system 106 utilizes the penalty minimization model 440 to update the attributes 450 based on the values of the attributes 450 that yield the greatest reduction in the document layout penalty 410.

In one or more embodiments, after updating the attributes 450, the hierarchical flow optimization system 106 determines the document layout penalty delta change 412 (e.g., utilizing the updated values for the attributes 450). For example, after applying the updated values for the attributes 450, the hierarchical flow optimization system 106 determines an updated value for the document layout penalty 410 based on updated values for n_{w}, nₒ, nₒ, nₙ, n_{g1}, and/or n_{g2}. For instance, for each iteration represented by FIG. 4A, the hierarchical flow optimization system 106 determines the document layout penalty delta change 412 based on a delta change to the document layout penalty 410 from the previous the document layout penalty 410 associated with the updated values of the attributes 450.

Furthermore, embodiments of the hierarchical flow optimization system 106 perform the act 420 to determine if the document layout penalty delta change 412 satisfies a penalty convergence threshold. In some cases, the hierarchical flow optimization system 106 determines whether the document layout penalty delta change 412 satisfies the penalty convergence threshold based a comparison of the document layout penalty delta change 412 to the penalty convergence threshold. In some cases, based on the document layout penalty delta change 412 meeting the penalty convergence threshold, the hierarchical flow optimization system 106 determines the updated values for the attributes 450 are the optimal attribute values 452 and does not further modify the attributes 450.

In some cases, based on the document layout penalty delta change 412 failing to meet the penalty convergence threshold, the hierarchical flow optimization system 106 repeats the cycle illustrated in FIG. 4A. For example, the hierarchical flow optimization system 106 selects attribute(s) Aᵢ from the attributes 450, utilizes the penalty minimization model 440 to update the attribute(s) Aᵢ, determines the document layout penalty delta change 412, and determines if the document layout penalty delta change 412 satisfies the penalty convergence threshold. Furthermore, embodiments of the hierarchical flow optimization system 106 iteratively repeat the cycle illustrated in FIG. 4A until the hierarchical flow optimization system 106 determines the document layout penalty delta change 412 meets the penalty convergence threshold. Based on the document layout penalty delta change 412 meeting the penalty convergence threshold, embodiments of the penalty minimization model update the values of the attributes 450.

Turning to FIG. 4B, as mentioned, embodiments of the hierarchical flow optimization system 106 utilize the penalty minimization model 440 to update the attributes 450. In some cases, the penalty minimization model 440 optimizes the value of the attribute Aᵢ to find a local minima (e.g., an attribute value that generates a local minima for the document layout penalty 410) utilizing gradient descent. FIG. 4B illustrates the hierarchical flow optimization system 106 utilizing the penalty minimization model 440 to update an attribute A ¿.

As shown, the penalty minimization model 440 utilizes gradient descent to modify the value of the attribute Aᵢ. For example, the penalty minimization model 440 begins with a default value for the attribute Aᵢ. Furthermore, the penalty minimization model 440 performs an act 460 to modify the attribute Aᵢ (e.g., Aᵢ→ΔᵢAᵢ). In some cases, the hierarchical flow optimization system 106 makes a delta change to the attribute Aᵢ, while keeping the other attributes (Aᵢ through Aₙ) constant.

Furthermore, embodiments of the hierarchical flow optimization system 106 perform an act 470 to determine a document layout penalty change 476 based on the delta change to the attribute Aᵢ (e.g., ΔᵢAᵢ). For example, the hierarchical flow optimization system 106 performs the act 470 utilizing the attribute ΔᵢAᵢ to generate a delta change for n_{w}, nₒ, nₚ, and nₙ with respect to the attribute Aᵢ denoted by

$$\frac{Δ {n}_{w}}{Δ {A}_{i}} , \frac{Δ {n}_{o}}{Δ {A}_{i}} , \frac{Δ {n}_{b}}{Δ {A}_{i}} , and \frac{Δ {n}_{n}}{Δ {A}_{i}} .$$

Furthermore, based on the delta change for n_{w}, nₒ, nₚ, and nₙ, embodiments of the hierarchical flow optimization system 106 generate a modified document layout penalty 472. By comparing a document layout penalty 474 (e.g., the initial document layout penalty 408) and the modified document layout penalty 472, embodiments of the hierarchical flow optimization system 106 determine a document layout penalty change 476 (e.g., ΔDLPᵢ) to the initial document layout penalty 408.

More specifically, embodiments of the hierarchical flow optimization system 106 perform an act 480 to modify the attribute Aᵢ. In some embodiments, the hierarchical flow optimization system 106 performs the act 480 to iteratively modify the attribute Aᵢ for a specified number of n iterations (e.g., repeating the act 460, the act 470, and the act 480 for n iterations). In some embodiments, the hierarchical flow optimization system 106 performs the act 480 to select to iteratively modify the attribute Aᵢ for a number of n iterations based on an attribute convergence threshold. For example, the hierarchical flow optimization system 106 performs iterations until ΔDLPᵢ meets the attribute convergence threshold or the value of document layout penalty change 476 indicates a local minima for the modified document layout penalty 472 (e.g., the modified document layout penalty 472 stops decreasing). In this way, embodiments of the hierarchical flow optimization system 106 generate n distinct values for the attribute Aᵢ, each representing a different adjustment made during the corresponding iteration. Thus, for n variations of Aᵢ (e.g., ΔᵢAᵢ), embodiments of the hierarchical flow optimization system 106 determine the modified document layout penalty 472 and the corresponding value for the document layout penalty change 476.

Furthermore, embodiments of the hierarchical flow optimization system 106 perform an act 490 to update the attribute value Aᵢ. For example, the hierarchical flow optimization system 106 updates the value of the attribute Aᵢ to the attribute ΔAᵢ corresponding to the iteration that resulted in the greatest reduction in the document layout penalty 474 (e.g., greatest value for the document layout penalty change 476).

As described in relation to FIGS. 4A-4B, one or more embodiments of the hierarchical flow optimization system 106 utilize the penalty minimization model 440 to update the attributes Aᵢ of the attributes 450. In this way, embodiments of the hierarchical flow optimization system 106 modify the attributes 450 interdependently to reduce disruptions to text flow of the digital document.

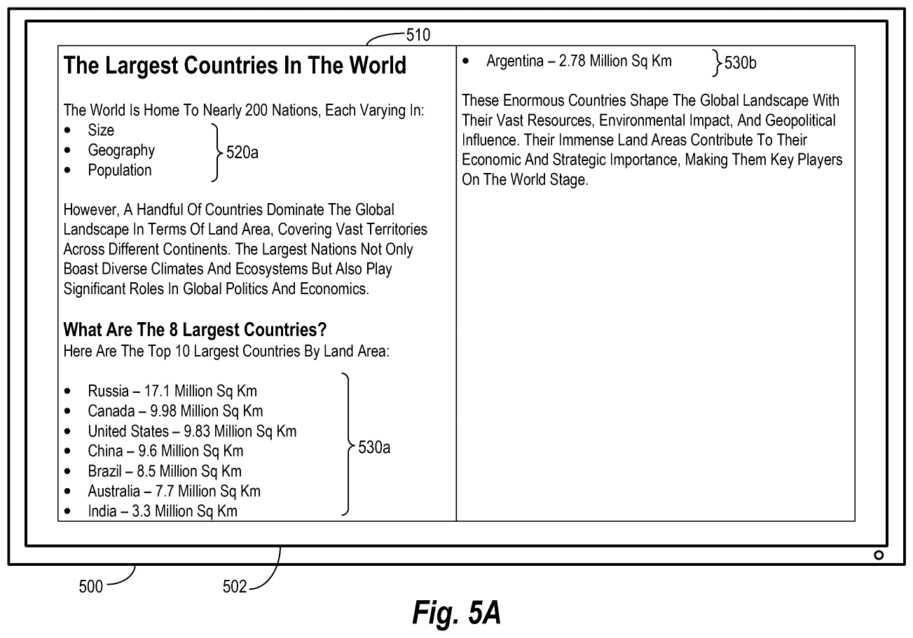

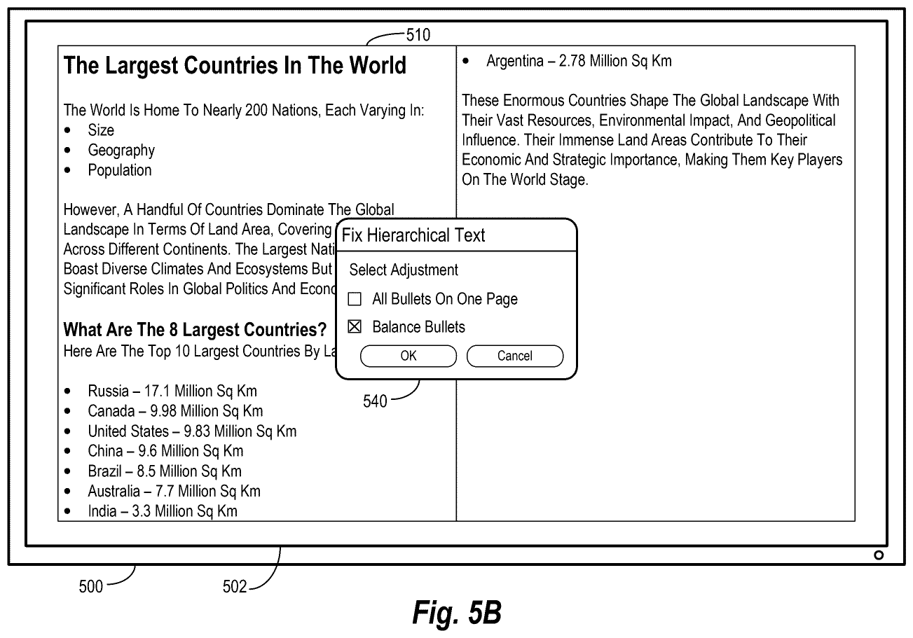

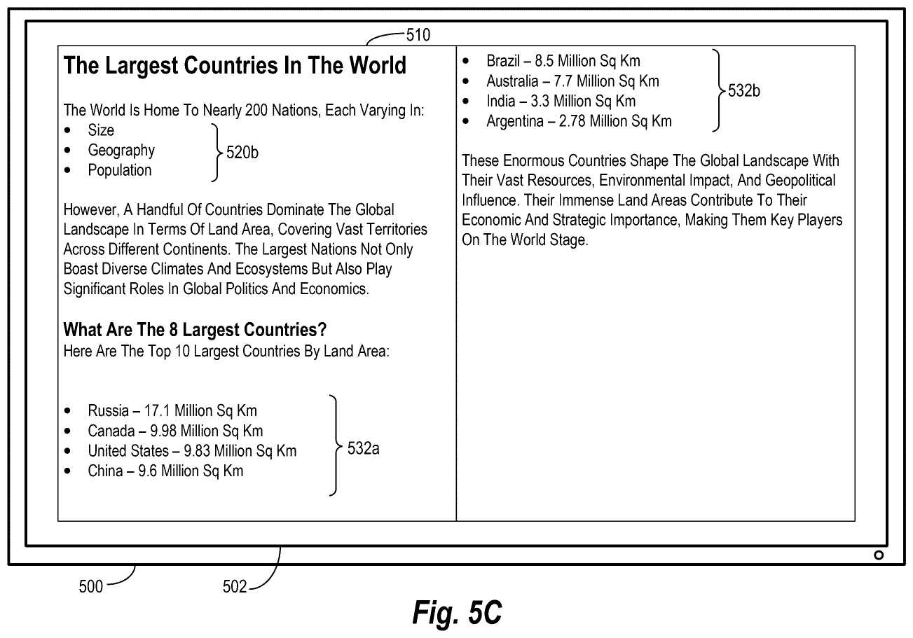

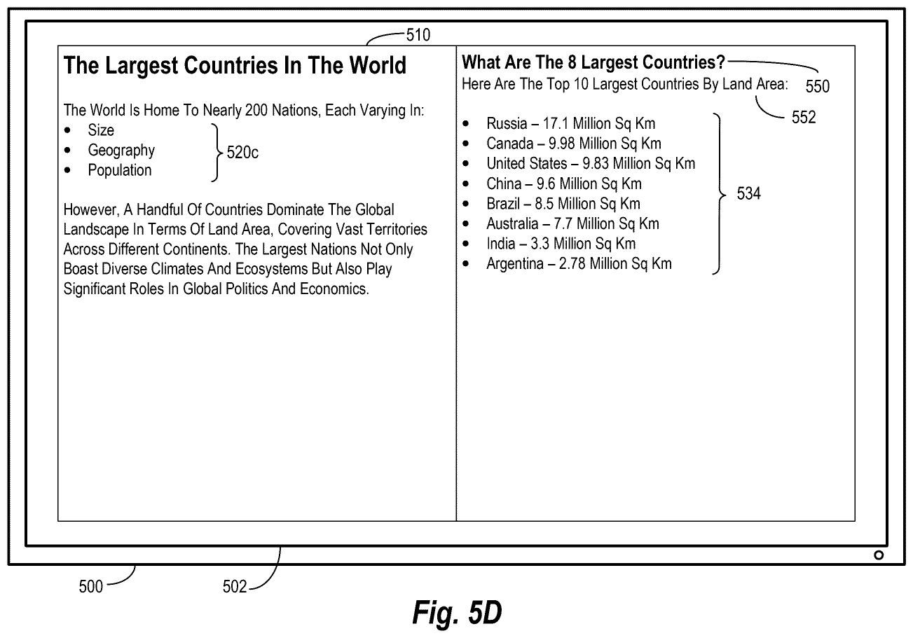

As mentioned, the hierarchical flow optimization system 106 provides a graphical user interface to adjust the display of hierarchical content of a digital document to reduce disruptions to text flow in the digital document. FIGS. 5A-5D illustrate an example of utilizing a graphical user interface of the hierarchical flow optimization system 106 to adjust the display of hierarchical content of a digital document in accordance with one or more embodiments.

For instance, as shown in FIG. 5A, the hierarchical flow optimization system 106 provides digital content for display on a graphical user interface 502 of a client device 500. In particular, the hierarchical flow optimization system 106 provides a digital document 510 for display, wherein the digital document 510 includes paragraph-based content and/or hierarchical content. For example, as shown in FIG. 5A, the digital document 510 includes a hierarchical segment corresponding to a bullet list 520a displayed grouped on a single page (or column/segment) of the digital document 510. Furthermore, the digital document 510 includes a hierarchical segment corresponding to a bullet list displayed split between two pages/sections (e.g., bullet list section 530a and bullet list section 530b) of the digital document 510.

Turning to FIG. 5B, in certain embodiments, the hierarchical flow optimization system 106 provides a flow selection element 540 to select to prioritize a type of adjustment/alignment for hierarchical content to reduce disruptions to text flow in the digital document 510. As shown in FIG. 5B, in some cases, the flow selection element 540 includes options to balance or group bullet lists within the digital document 510. In some cases, the flow selection element 540 includes an option to balance or group numbered lists in the digital document 510. Similarly, in some embodiments, the flow selection element 540 includes option(s) to balance or group various types of content elements within the digital document 510 (e.g., paragraphs, table of contents, indexes, etc.).

As shown in FIG. 5C, based on a selection of the flow selection element 540 to balance the bullet lists within the digital document 510, the hierarchical flow optimization system 106 balances the first bullet list (e.g., bullet list 520b) and the second bullet list (e.g., bullet list section 532a and bullet list section 532b) by adjusting attributes of the digital document 510, as described above in relation to FIGS. 1-4B. For example, the hierarchical flow optimization system 106 balances the bullet lists by dividing the bullet lists into two equal groups of bullets (or approximately equal for the uneven numbers of bullets in the bullet list 520b) to balance the hierarchical elements. As shown, the hierarchical flow optimization system 106 balances the bullet list 520b by adjusting attributes of the digital document 510 to maintain the two groups of bullets corresponding to the bullet list 520b on the same page of the digital document 510. As also shown, the hierarchical flow optimization system 106 adjusts the attributes of the digital document 510 to balance the second bullet list by splitting the second bullet list equally between the pages (e.g., the bullet list section 532a and the bullet list section 532b) of the digital document 510.

Alternatively, as shown in FIG. 5D, based on a selection of the flow selection element 540 to group bullet lists within the digital document 510, the hierarchical flow optimization system 106 balances bullet list 520c and bullet list 534 by adjusting attributes of the digital document 510, as described above in relation to FIGS. 1-4B. For example, the hierarchical flow optimization system 106 adjusts attributes to group the bullet list 520c and maintain the elements of the bullet list 520c on the same page (or column/section) of the digital document 510. As also shown, the hierarchical flow optimization system 106 balances bullet list 534, by adjusting the attributes of the digital document and grouping the elements of the bullet list 534 equally on the same page (or column/section) of the digital document 510.

Notably, the hierarchical flow optimization system 106 utilizes a document layout penalty for the digital document 510 based on the non-hierarchical content and the hierarchical content of the digital document 510. For example, the hierarchical flow optimization system 106 balances the bullet lists of the digital document 510 based on a combined disruption to the text flow caused by the non-hierarchical content and the hierarchical content within the digital document 510. Similarly, based on determining the document layout penalty, the hierarchical flow optimization system 106 causes subtitle 550 and introductory text 552 to be grouped on the same page as the bullet list 534 based on a combined disruption to the text flow caused by the non-hierarchical content and the hierarchical content within the digital document 510. By utilizing the document layout penalty for the digital document 510, embodiments of the hierarchical flow optimization system 106 minimize the aggregate disruption to the text flow within the digital document.

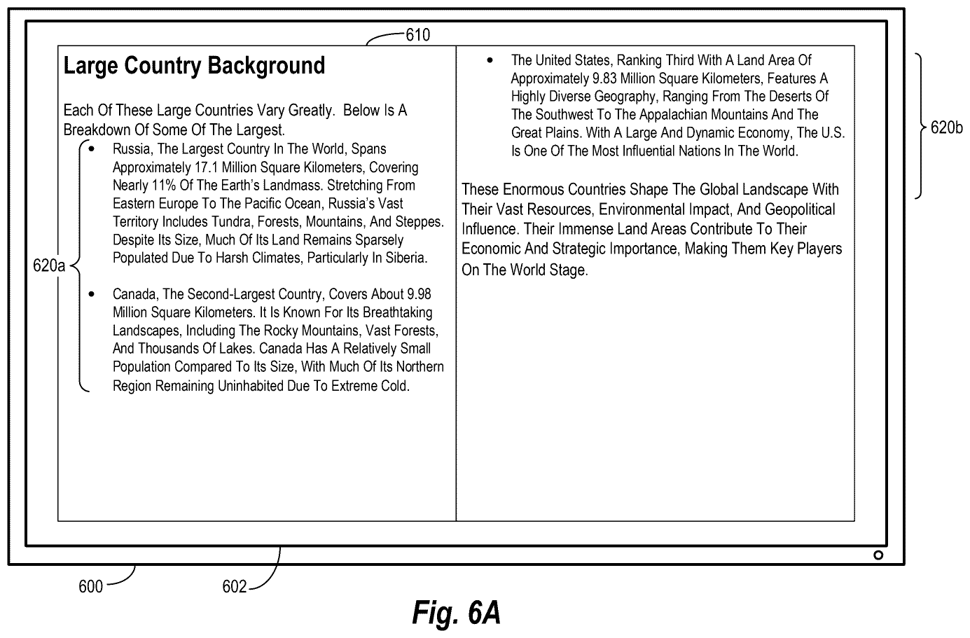

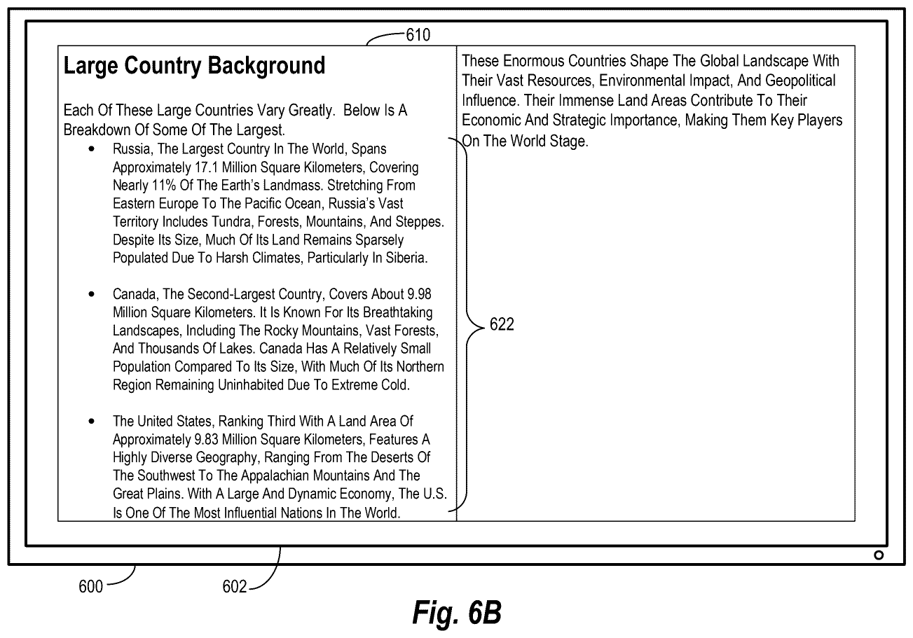

As mentioned, the hierarchical flow optimization system 106 provides a graphical user interface to adjust a variety of hierarchical content within a digital document to reduce disruptions to text flow in the digital document. FIGS. 6A-6B illustrate an example of utilizing a graphical user interface of a hierarchical flow optimization system to adjust the display of paragraphs of hierarchical content within a digital document in accordance with one or more embodiments.

For instance, as shown in FIG. 6A, the hierarchical flow optimization system 106 provides a digital document 610 for display on a graphical user interface 602 of a client device 600. In particular, the hierarchical flow optimization system 106 displays the digital document 610 wherein the digital document includes hierarchical content that incorporates multi-line paragraph elements. For example, as shown in FIG. 6A, the digital document 610 includes hierarchical content of a bullet list that is split between two pages (e.g., bullet list section 620a and bullet list section 620b) of the digital document 610. Furthermore, the isolated element corresponding to the bullet list section 620b is a multi-line paragraph bullet isolated on a separate page of the digital document 610.

As shown in FIG. 6B, based on a selection to group bullet lists within the digital document, the hierarchical flow optimization system 106 groups the elements of bullet list 622 by adjusting attributes of the digital document, as described above in relation to FIGS. 1-4B. In certain embodiments, the hierarchical flow optimization system 106 adjusts the attributes of the digital document to group the bullet list 622, by grouping the elements of the bullet list 622 onto the same page (or column) of the digital document 610. As shown, the hierarchical flow optimization system 106 balances the bullet list 622 based on the disruption to the text flow caused by the paragraph element of the hierarchical content within the digital document (and not an isolated line of content).

Similarly, embodiments of the hierarchical flow optimization system 106 group or balance other types of hierarchical content as described above. For example, the hierarchical flow optimization system 106 groups or balances multi-line hierarchical elements that are split between pages to reduce the overall disruption to the text flow within the digital document. In some cases, the hierarchical flow optimization system 106 groups or balances a group of nested hierarchical elements where the group of nested hierarchical content disrupts the text flow within the digital document. For example, the hierarchical flow optimization system 106 identifies groups of nested elements as a logical unit and enforces constraints to avoid breaking nested relationships (e.g., keeping list-items with their parent bullet or number, keeping at least two nested elements together on a page, keeping subheadings with at least two following lines of content, or maintaining indented subpoints with their parent point).

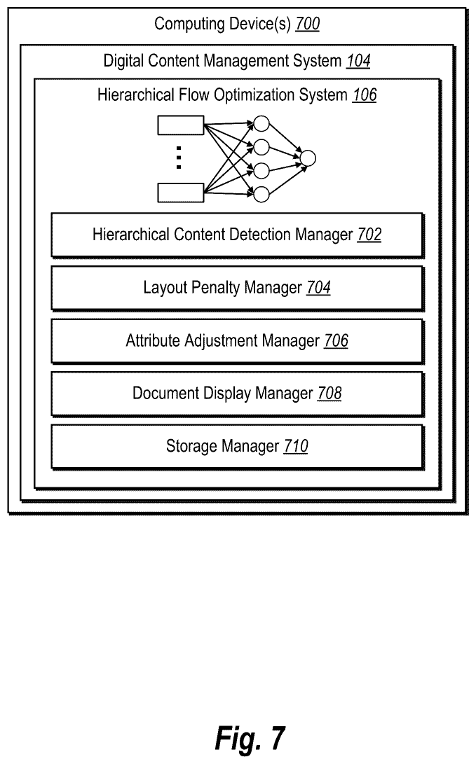

Turning now to FIG. 7, additional detail will now be provided regarding various components and capabilities of the hierarchical flow optimization system 106. In particular, FIG. 7 illustrates the hierarchical flow optimization system 106 implemented by the computing device 700 (e.g., the server device(s) 102 and/or one of the client device(s) 110 discussed above with reference to FIG. 1). Additionally, the hierarchical flow optimization system 106 is also part of the digital content management system 104. As shown in FIG. 7, the hierarchical flow optimization system 106 includes, but is not limited to, a hierarchical content detection manager 702, a layout penalty manager 704, an attribute adjustment manager 706, a document display manager 708, and a data storage manager 710.

As just mentioned, and as illustrated in FIG. 7, the hierarchical flow optimization system 106 includes the hierarchical content detection manager 702. In one or more embodiments, the hierarchical content detection manager 702 manages the detection of hierarchical content within the digital document. For example, the hierarchical content detection manager 702 detects, within the digital document, one or more hierarchical segments in response to a selection of a document layout analysis tool via a graphical user interface displaying the digital document. In some cases, the hierarchical content detection manager 702 detects isolated elements within the hierarchical segments of the digital document.

As further shown in FIG. 7, the hierarchical flow optimization system 106 includes the layout penalty manager 704. In one or more embodiments, the layout penalty manager 704 determines a document layout penalty. For example, the layout penalty manager 704 determines a document layout penalty that quantifies the disruption to the text flow of the digital document caused by isolated elements of content within the digital document. In certain cases, the layout penalty manager 704 determines the document layout penalty based on the severity of the disruption. In one or more embodiments, the layout penalty manager 704 weights the isolated elements from different types of textual segments independently in the document layout penalty, reflective of a varying disruptive impact of the isolated elements from different types of textual segments to the text flow of the digital document.

As also shown in FIG. 7, the hierarchical flow optimization system 106 utilizes the attribute adjustment manager 706 to update the attributes of the digital document and reduce the document layout penalty (thereby reducing disruption to text flow). In some cases, the attribute adjustment manager 706 modifies typographical attributes of the digital document including justification, hyphenation, glyph spacing, word spacing, and/or glyph scaling. In certain embodiments, the attribute adjustment manager 706 performs iterative modifications to the attributes to reduce the document layout penalty. For example, the attribute adjustment manager 706 iteratively modifies the attributes until reaching convergence (e.g., until changes to the document layout penalty become negligible or meet a penalty convergence threshold).

In one or more embodiments, the hierarchical flow optimization system 106 utilizes the document display manager 708 to provide digital content for display on a graphical user interface of a client device. In particular, the document display manager 708 displays a digital document, wherein the digital document includes paragraph-based content and/or hierarchical content. In some cases, the document display manager 708 displays changes to the layout of the digital document based on changes to the typographical attributes of the digital document. For example, after determining optimal values for the typographical attributes that minimize a disruption to the text flow of the digital document, the document display manager 708 displays an updated digital document based on the optimal attribute values.

Additionally, as shown, the hierarchical flow optimization system 106 includes the data storage manager 710. In particular, the data storage manager 710 (implemented by one or more memory devices) stores digital documents, hierarchical content, non-hierarchical content, document attributes, and document layout penalties. The data storage manager 710 facilitates the modification and display of digital documents by the hierarchical flow optimization system 106.

Each of the components 700-710 of the hierarchical flow optimization system 106 includes software, hardware, or both. For example, the components 700-710 include one or more instructions stored on a computer-readable storage medium and executable by processors of one or more computing devices, such as a client device or server device. When executed by the one or more processors, the computer-executable instructions of the hierarchical flow optimization system 106 causes the computing device(s) to perform the methods described herein.

Alternatively, the components 700-710 include hardware, such as a special-purpose processing device to perform a certain function or group of functions. Alternatively, the components 700-710 of the hierarchical flow optimization system 106 include a combination of computer-executable instructions and hardware.

Furthermore, the components 700-710 of the hierarchical flow optimization system 106 are implemented as one or more operating systems, as one or more stand-alone applications, as one or more modules of an application, as one or more plug-ins, as one or more library functions or functions called by other applications, and/or as a cloud-computing model. Thus, in some embodiments, the components 700-710 of the hierarchical flow optimization system 106 are implemented as a stand-alone application, such as a desktop or mobile application. Furthermore, in some embodiments, the components 700-710 of the hierarchical flow optimization system 106 are implemented as one or more web-based applications hosted on a remote server. Alternatively, or additionally, the components 700-710 of the hierarchical flow optimization system 106 are implemented in a suite of mobile device applications or “apps.” For example, in one or more embodiments, the hierarchical flow optimization system 106 comprises or operates in connection with digital software applications such as: ADOBE® EXPRESS®, ADOBE® INDESIGN CC, ADOBE® INCOPY CC, and ADOBE® DOCUMENT CLOUD®. The foregoing are either registered trademarks or trademarks of Adobe Inc. in the United States and/or other countries.

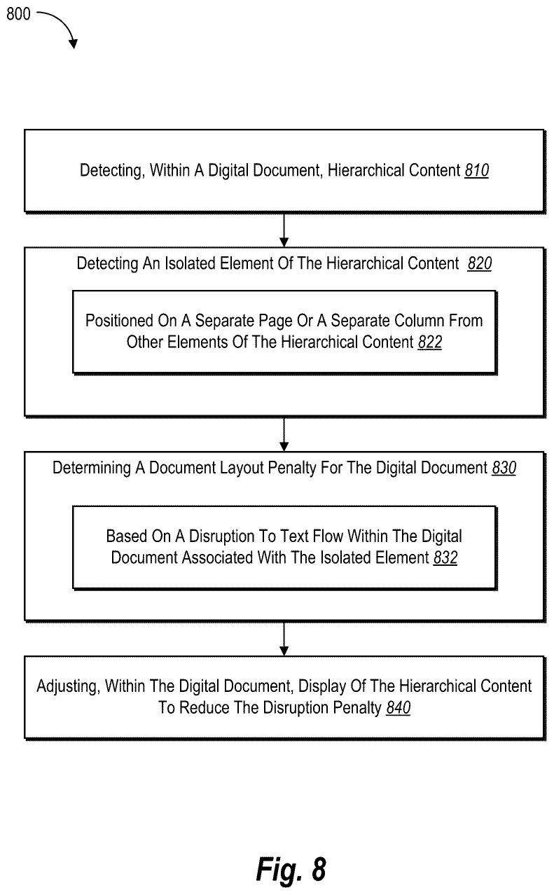

FIGS. 1-10, the corresponding text, and the examples provide a number of different methods, systems, devices, and non-transitory computer-readable media of the hierarchical flow optimization system 106. In addition to the foregoing, one or more embodiments are also described in terms of flowcharts comprising acts for accomplishing a particular result, as shown in FIG. 8. In some embodiments, the acts shown in FIG. 8 are performed in connection with more or fewer acts. Further, the acts may be performed in differing orders. Additionally, in various embodiments, the acts described herein are repeated or performed in parallel with one another or parallel with different instances of the same or similar acts. A non-transitory computer-readable medium includes instructions that, when executed by one or more processors, cause a computing device to perform the acts of FIG. 8. In some embodiments, a system is configured to perform the acts of FIG. 8. Alternatively, the acts of FIG. 8 are performed as part of a computer-implemented method.

FIG. 8 illustrates a flowchart of a series of acts for finetuning a large language model by modifying parameters based on a preference dataset in accordance with one or more embodiments. While FIG. 8 illustrates acts according to one embodiment, alternative embodiments omit, add to, reorder, and/or modify any acts shown in FIG. 8.

FIG. 8 illustrates an example series of acts 800 for utilizing a hierarchical flow optimization system 106 to adjust the display of hierarchical content to reduce disruption to text flow. In particular, in certain embodiments, the series of acts 800 includes an act 810 of detecting, within a digital document, hierarchical content. Specifically, in one or more embodiments, the act 810 includes detecting, within a digital document, a hierarchical segment comprising a hierarchical organization of textual elements in response to a selection of a document layout analysis tool via a graphical user interface displaying the digital document. In particular, in certain embodiments, the series of acts 800 includes an act 820 of detecting an isolated element of the hierarchical content. In some embodiments, the series of acts includes a sub-act 822 of detecting an isolated element of the hierarchical content positioned on a separate page or a separate column from other elements of the hierarchical segment. In particular, in one or more embodiments, the act 820 includes detecting, within the digital document, an isolated element of the hierarchical segment positioned on a separate page or a separate column from other elements of the hierarchical segment.

As illustrated, in some embodiments, the series of acts 800 also includes an act 830 of determining a document layout penalty for the digital document. In some embodiments, the series of acts includes a sub-act 832 of determining a document layout penalty for the digital document based on a disruption to text flow within the digital document associated with the isolated element. In particular, in one or more embodiments, the act 830 includes determining a document layout penalty for the digital document based on a disruption to text flow within the digital document associated with the isolated element. Additionally, in one or more embodiments, the series of acts 800 also includes an act 840 adjusting, within the digital document, display of the hierarchical content to reduce the document layout penalty. In particular, in one or more embodiments, the act 840 includes adjusting, within the digital document, display of the hierarchical segment by modifying attributes of the digital document to reduce the document layout penalty.

In addition (or in the alternative) to the acts described above, in certain embodiments, the hierarchical flow optimization system series of acts 800 also includes detecting an additional isolated element of an additional segment positioned on a separate page or a separate column from other elements of the additional segment. In some embodiments, the series of acts 800 also includes determining the document layout penalty for the digital document based on an additional disruption to text flow within the digital document associated with the additional isolated element. Moreover, in one or more embodiments, the hierarchical flow optimization system 106 series of acts 800 includes detecting the additional segment of an additional type of content comprising paragraph-based segments of textual paragraphs. Further still, in some embodiments, the hierarchical flow optimization system 106 series of acts 800 includes detecting, within the digital document, an isolated line of textual content of the additional segment positioned on a separate page or a separate column from other elements of the additional segment.

Furthermore, in one or more embodiments, the hierarchical flow optimization system series of acts 800 includes detecting, within the digital document, an isolated multi-line bullet-point comprising a plurality of lines of textual content positioned on a separate page or a separate column from other elements of the hierarchical segment. Moreover, one or more embodiments, the series of acts 800 includes detecting, within the digital document, an isolated multi-line list-item comprising a plurality of lines of textual content positioned on a separate page or a separate column from other elements of the hierarchical segment. Further still, in one or more embodiments, the series of acts 800 includes receiving, via the document layout analysis tool, a flow selection comprising a selection to balance elements of the hierarchical segment between pages or columns within the digital document or a selection to group the elements of the hierarchical segment on a page or a column within the digital document. Moreover, in one or more embodiments, the series of acts 800 includes adjusting the display of the hierarchical segment based on the flow selection.

Moreover, one or more embodiments, the series of acts 800 includes modifying typographical attributes of the digital document utilizing gradient descent by iteratively modifying a typographical attribute to satisfy an attribute convergence threshold. Furthermore, in one or more embodiments, the series of acts 800 includes iteratively modifying an additional typographical attribute to satisfy the attribute convergence threshold. Moreover, in one or more embodiments, the series of acts 800 includes determining that the document layout penalty satisfies a penalty convergence threshold. In one or more embodiments, the series of acts 800 includes determining a spill severity corresponding to a size of content spill for the isolated element onto the separate page or the separate column in comparison with a size of the hierarchical segment. Further still, in one or more embodiments, the series of acts 800 includes normalizing the spill severity based on a size of the digital document.

In one or more embodiments, the series of acts 800 further includes detect, within a digital document and in response to a selection of a document layout analysis tool via a graphical user interface displaying the digital document, a first type of content comprising hierarchical segments of hierarchically organized textual elements and a second type of content comprising paragraph-based segments of textual paragraphs. In addition, in one or more embodiments, the series of acts 800 includes determine a first penalty by weighting a disruption to text flow within the digital document caused by instances of the first type of segment and a second penalty by weighting a disruption to text flow within the digital document caused by instances of the second type of segment. Furthermore, in one or more embodiments, the series of acts 800 includes determine a document layout penalty for the digital document by combining the first penalty and the second penalty. In addition, in one or more embodiments, the series of acts 800 includes adjust, within the digital document, display of the hierarchical segments or the paragraph-based segments by modifying attributes of the digital document to reduce the document layout penalty.

Moreover, in one or more embodiments, the series of acts 800 includes detecting, within a hierarchical segment of the digital document, an isolated multi-line element positioned on a separate page or a separate column from other elements of the hierarchical segment. In one or more embodiments, the series of acts 800 includes determining the document layout penalty for the digital document based on a disruption to text flow within the digital document associated with the isolated multi-line element.

Furthermore, in one or more embodiments, the series of acts 800 includes receiving, via the document layout analysis tool, a flow selection comprising a selection to balance elements of the hierarchical segments between pages or columns within the digital document or a selection to group the elements of the hierarchical segments on pages or columns within the digital document. In some embodiments, the series of acts 800 also includes reducing the document layout penalty based on the flow selection. Moreover, in one or more embodiments, the hierarchical flow optimization system 106 series of acts 800 includes modifying typographical attributes of the digital document utilizing gradient descent by iteratively modifying typographical attributes to satisfy a penalty convergence threshold.

Further still, in some embodiments, the hierarchical flow optimization system 106 series of acts 800 includes iteratively modifying typographical attributes until a delta change in the document layout penalty satisfies a penalty convergence threshold. Furthermore, in one or more embodiments, the hierarchical flow optimization system series of acts 800 includes determining a spill severity corresponding to sizes of isolated elements of the hierarchical segments in relation to sizes of the hierarchical segments. Further still, in one or more embodiments, the series of acts 800 includes normalizing the spill severity based on a size of the digital document.

Moreover, in one or more embodiments, the series of acts 800 includes detecting, within a digital document, a hierarchical segment comprising a hierarchical organization of textual elements in response to a selection of a document layout analysis tool via a graphical user interface displaying the digital document. In certain embodiments, the series of acts 800 further includes detecting, within the digital document, an isolated element of the hierarchical segment positioned on a separate page or a separate column from other elements of the hierarchical segment. Moreover, one or more embodiments, the series of acts 800 includes determining a document layout penalty for a content disruption to text flow within the digital document associated with the isolated element for the digital document. For example, the series of acts 800 determines the document layout penalty by determining a plurality of penalties indicating a disruption to text flow within the digital document according to a plurality of types of content in the digital document. The series of acts 800 also determines the document layout penalty by determining a spill severity corresponding to a size of content spill for the isolated element onto the separate page or the separate column in comparison with a size of the hierarchical segment. Moreover, one or more embodiments, the series of acts 800 includes adjusting, within the digital document, display of the hierarchical segment by modifying attributes of the digital document to reduce the document layout penalty.

Furthermore, in one or more embodiments, the series of acts 800 includes detecting an additional isolated element of an additional segment positioned at a top of a page or at a top of a column separated from other elements of the additional segment. Moreover, in one or more embodiments, the series of acts 800 includes determining the document layout penalty for the digital document based on an additional disruption to text flow within the digital document associated with the additional isolated element. In one or more embodiments, the series of acts 800 includes detecting the additional segment of an additional type of content comprising paragraph-based segments of textual paragraphs. Further still, in one or more embodiments, the series of acts 800 includes detecting, within the digital document, an isolated line of textual content positioned at the top the page or at the top of the column separated from other elements of the additional segment.

In one or more embodiments, the series of acts 800 further includes detecting, within the digital document, an isolated multi-line element comprising a plurality of lines of textual content positioned on a separate page or a separate column from other elements of the hierarchical segment. In addition, in one or more embodiments, the series of acts 800 includes providing, via a graphical user interface displaying the digital document, the document layout analysis tool comprising a plurality of options for indicating a configuration for the hierarchical organization of textual elements.

In addition, in one or more embodiments, the series of acts 800 includes receiving, via the document layout analysis tool, a flow selection from the plurality of options comprising a selection to balance elements of the hierarchical segment between pages or columns within the digital document. Furthermore, in one or more embodiments, the series of acts 800 includes receiving, via the document layout analysis tool, a flow selection from the plurality of options comprising a selection to group the elements of the hierarchical segment on a same page or a same column within the digital document. Further still, in one or more embodiments, the series of acts 800 includes determining the document layout penalty based on the flow selection. Furthermore, in one or more embodiments, the series of acts 800 includes iteratively modifying typographical attributes of the digital document to satisfy a penalty convergence threshold.

Embodiments of the present disclosure may comprise or utilize a special purpose or general-purpose computer including computer hardware, such as, for example, one or more processors and system memory, as discussed in greater detail below. Embodiments within the scope of the present disclosure also include physical and other computer-readable media for carrying or storing computer-executable instructions and/or data structures. In particular, one or more of the processes described herein may be implemented at least in part as instructions embodied in a non-transitory computer-readable medium and executable by one or more computing devices (e.g., any of the media content access devices described herein). In general, a processor (e.g., a microprocessor) receives instructions, from a non-transitory computer-readable medium, (e.g., a memory, etc.), and executes those instructions, thereby performing one or more processes, including one or more of the processes described herein.

Computer-readable media can be any available media that can be accessed by a general purpose or special purpose computer system. Computer-readable media that store computer-executable instructions are non-transitory computer-readable storage media (devices). Computer-readable media that carry computer-executable instructions are transmission media. Thus, by way of example, and not limitation, embodiments of the disclosure can comprise at least two distinctly different kinds of computer-readable media: non-transitory computer-readable storage media (devices) and transmission media. Non-transitory computer-readable storage media (devices) includes optical and/or non-optical memory, disks, or caches that store computer data interpretable by one or more processors to execute particular functions as described herein. A “network” is defined as one or more data links that enable the transport of electronic data between computer systems and/or modules and/or other electronic devices. Information is transferred or provided over a network (either hardwired, wireless, or a combination of hardwired or wireless) to a computer to carry program code in the form of computer-executable instructions or data structures and which can be accessed by a general purpose or special purpose computer.

Computer-executable instructions comprise, for example, instructions and data which, when executed at a processor, cause a general-purpose computer, special purpose computer, or special purpose processing device to perform a certain function or group of functions. In some embodiments, computer-executable instructions are executed on a general-purpose computer to turn the general-purpose computer into a special purpose computer implementing elements of the disclosure. The computer executable instructions may be, for example, binaries, intermediate format instructions such as assembly language, or even source code.

Embodiments of the present disclosure can also be implemented in cloud computing environments. In this description, “cloud computing” is defined as a model for enabling on-demand network access to a shared pool of configurable computing resources. A cloud-computing model can also expose various service models, such as, for example, Software as a Service (“SaaS”), Platform as a Service (“PaaS”), and Infrastructure as a Service (“IaaS”). A cloud-computing model can also be deployed using different deployment models such as private cloud, community cloud, public cloud, hybrid cloud, and so forth.

FIG. 9 illustrates, in block diagram form, an example computing device 900 (e.g., the computing device 900, the client device(s) 110, and/or the server device(s) 102) that may be configured to perform one or more of the processes described above. As shown by FIG. 9, the computing device can comprise a processor(s) 902, memory 904, a storage device 906, an I/O interface 908, and a communication interface 910.

In particular embodiments, processor(s) 902 includes hardware for executing instructions, such as those making up a computer program. As an example, and not by way of limitation, to execute instructions, processor(s) 902 may retrieve (or fetch) the instructions from an internal register, an internal cache, memory 904, or a storage device 906 and decode and execute them. The computing device 900 includes memory 904, which is coupled to the processor(s) 902. The memory 904 may be used for storing data, metadata, and programs for execution by the processor(s). The memory 904 may include one or more of volatile and non-volatile memories. The memory 904 may be internal or distributed memory. The computing device 900 includes a storage device 906 includes storage for storing data or instructions. As an example, and not by way of limitation, storage device 906 can comprise a non-transitory storage medium described above. The computing device 900 also includes one or more input or output (“I/O”) devices/interfaces 908, which are provided to allow a user to provide input to (such as user strokes), receive output from, and otherwise transfer data to and from the computing device 900. These I/O devices/interfaces 908 may include a mouse, keypad or a keyboard, a touch screen, camera, optical scanner, network interface, modem, other known I/O devices or a combination of such I/O devices/interfaces 908.

The computing device 900 can further include a communication interface 910. The communication interface 910 can include hardware, software, or both. The communication interface 910 can provide one or more interfaces for communication (such as, for example, packet-based communication) between the computing device and one or more other computing devices (e.g., computing device 900) or one or more networks. The computing device 900 can further include a bus 912. The bus 912 can comprise hardware, software, or both that couples components of computing device 900 to each other.

1. A computer-implemented method comprising:
detecting, within a digital document, a hierarchical segment comprising a hierarchical organization of textual elements in response to a selection of a document layout analysis tool via a graphical user interface displaying the digital document;
detecting, within the digital document, an isolated element of the hierarchical segment positioned on a separate page or a separate column from other elements of the hierarchical segment;
determining a document layout penalty for the digital document based on a disruption to text flow within the digital document associated with the isolated element; and
adjusting, within the digital document, display of the hierarchical segment by modifying attributes of the digital document to reduce the document layout penalty.

2. The computer-implemented method of claim 1, further comprising:
detecting an additional isolated element of an additional segment positioned on a separate page or a separate column from other elements of the additional segment; and
wherein determining the document layout penalty for the digital document further comprises determining the document layout penalty for the digital document based on an additional disruption to text flow within the digital document associated with the additional isolated element.

3. The computer-implemented method of claim 2, wherein detecting the additional isolated element of the additional segment further comprises:
detecting the additional segment of an additional type of content comprising paragraph-based segments of textual paragraphs; and
detecting, within the digital document, an isolated line of textual content of the additional segment positioned on a separate page or a separate column from other elements of the additional segment.

4. The computer-implemented method of claim 1, wherein detecting an isolated element of the hierarchical segment further comprises:
detecting, within the digital document, an isolated multi-line bullet-point comprising a plurality of lines of textual content positioned on a separate page or a separate column from other elements of the hierarchical segment; or
detecting, within the digital document, an isolated multi-line list-item comprising a plurality of lines of textual content positioned on a separate page or a separate column from other elements of the hierarchical segment.

5. The computer-implemented method of claim 1, further comprising:
receiving, via the document layout analysis tool, a flow selection comprising:
a selection to balance elements of the hierarchical segment between pages or columns within the digital document; or
a selection to group the elements of the hierarchical segment on a page or a column within the digital document; and
wherein adjusting the display of the hierarchical segment further comprises adjusting the display of the hierarchical segment based on the flow selection.

6. The computer-implemented method of claim 1, wherein adjusting the display of the hierarchical segment further comprises modifying typographical attributes of the digital document utilizing gradient descent with an objective function:
selecting a typographical attribute of the digital document based on a variability of the typographical attribute relative to other typographical attributes of the digital document; and
iteratively modifying attribute values of the typographical attribute to satisfy an attribute convergence threshold.

7. The computer-implemented method of claim 6, further selecting an additional typographical attribute of the digital document based on a variability of the typographical attribute;
iteratively modifying attribute values of the additional typographical attribute to satisfy the attribute convergence threshold; and
determining that the document layout penalty satisfies a penalty convergence threshold.

8. The computer-implemented method of claim 1, wherein determining the document layout penalty further comprises:
determining a spill severity corresponding to a size of content spill for the isolated element onto the separate page or the separate column in comparison with a size of the hierarchical segment; and
normalizing the spill severity based on a size of the digital document.

9. A system comprising:
one or more memory devices; and
one or more processors configured to cause the system to:
detect, within a digital document and in response to a selection of a document layout analysis tool via a graphical user interface displaying the digital document, a first type of content comprising hierarchical segments of hierarchically organized textual elements and a second type of content comprising paragraph-based segments of textual paragraphs;
determine a first penalty by weighting a disruption to text flow within the digital document caused by instances of the first type of segment and a second penalty by weighting a disruption to text flow within the digital document caused by instances of the second type of segment;
determine a document layout penalty for the digital document by combining the first penalty and the second penalty; and
adjust, within the digital document, display of the hierarchical segments or the paragraph-based segments by modifying attributes of the digital document to reduce the document layout penalty.

10. The system of claim 9, further comprising:
detecting, within a hierarchical segment of the digital document, an isolated multi-line element positioned on a separate page or a separate column from other elements of the hierarchical segment; and
wherein determining the document layout penalty further comprises determining the document layout penalty for the digital document based on a disruption to text flow within the digital document associated with the isolated multi-line element.

11. The system of claim 9, further comprising:
receiving, via the document layout analysis tool, a flow selection comprising:
a selection to balance elements of the hierarchical segments between pages or columns within the digital document; or
a selection to group the elements of the hierarchical segments on pages or columns within the digital document; and
adjusting the display of the hierarchical segments or the paragraph-based segments by reducing the document layout penalty based on the flow selection.

12. The system of claim 9, further comprising, wherein reducing adjusting the display of the hierarchical segments or the paragraph-based segments further comprises modifying typographical attributes of the digital document utilizing gradient descent by iteratively modifying typographical attributes to satisfy a penalty convergence threshold.

13. The system of claim 12, wherein iteratively modifying typographical attributes to satisfy a penalty convergence threshold further comprises iteratively modifying typographical attributes until a delta change in the document layout penalty satisfies a penalty convergence threshold.

14. The system of claim 9, wherein determining the document layout penalty further comprises:
determining a spill severity corresponding to sizes of isolated elements of the hierarchical segments in relation to sizes of the hierarchical segments; and
normalizing the spill severity based on a size of the digital document.

15. A non-transitory computer readable medium storing executable instructions which, when executed by a processing device, cause the processing device to perform operations comprising:
detecting, within a digital document, a hierarchical segment comprising a hierarchical organization of textual elements in response to a selection of a document layout analysis tool via a graphical user interface displaying the digital document;
detecting, within the digital document, an isolated element of the hierarchical segment positioned on a separate page or a separate column from other elements of the hierarchical segment;
determining a document layout penalty for a content disruption to text flow within the digital document associated with the isolated element for the digital document by:
determining a plurality of penalties indicating a disruption to text flow within the digital document according to a plurality of types of content in the digital document; and
determining a spill severity corresponding to a size of content spill for the isolated element onto the separate page or the separate column in comparison with a size of the hierarchical segment; and
adjusting, within the digital document, display of the hierarchical segment by modifying attributes of the digital document to reduce the document layout penalty.

16. The non-transitory computer readable medium of claim 15, further comprising:
detecting an additional isolated element of an additional segment positioned at a top of a page or at a top of a column separated from other elements of the additional segment; and
determining the document layout penalty for the digital document based on an additional disruption to text flow within the digital document associated with the additional isolated element.

17. The non-transitory computer readable medium of claim 16, further comprising, wherein detecting the additional isolated element of the additional segment further comprises:
detecting the additional segment of an additional type of content comprising paragraph-based segments of textual paragraphs; and
detecting, within the digital document, an isolated line of textual content positioned at the top the page or at the top of the column separated from other elements of the additional segment.

18. The non-transitory computer readable medium of claim 15, wherein detecting an isolated element of the hierarchical segment positioned on a separate page or a separate column from other elements of the hierarchical segment further comprises detecting, within the digital document, an isolated multi-line element comprising a plurality of lines of textual content positioned on a separate page or a separate column from other elements of the hierarchical segment.

19. The non-transitory computer readable medium of claim 16, further comprising:
providing, via a graphical user interface displaying the digital document, the document layout analysis tool comprising a plurality of options for indicating a configuration for the hierarchical organization of textual elements;
receiving, via the document layout analysis tool, a flow selection from the plurality of options comprising:
a selection to balance elements of the hierarchical segment between pages or columns within the digital document; or
a selection to group the elements of the hierarchical segment on a same page or a same column within the digital document; and
determining the document layout penalty based on the flow selection.

20. The non-transitory computer readable medium of claim 16, wherein adjusting display of the hierarchical segment further comprises iteratively modifying typographical attributes of the digital document to satisfy a penalty convergence threshold.
